(19) United States
(12) Patent Application Publication
(10) Pub. No.: US 2007/0163188 A1
(43) Pub. Date: Jul. 19, 2007

(54) Wall system

(76) Inventor: Raymond R. Price, Rochester, MN (US)

Correspondence Address: MOORE & HANSEN, PLLP, 225 SOUTH SIXTH ST, MINNEAPOLIS, MN, 55402, US

(21) Appl. No.: 11/484,133

(22) Filed: Jul. 10, 2006

Related U.S. Application Data
(63) Continuation of application No. 10/395,608, filed on Mar. 24, 2003.
Application No. 10/395,608 is a continuation-in-part of application No. 10/015,052, filed on Dec. 11, 2001, now Pat. No. 6,691,471.
Application No. 10/015,052 is a continuation-in-part of application No. 09/547,206, filed on Apr. 12, 2000, now Pat. No. 6,374,552.
(63) Continuation-in-part of application No. 10/363,999, filed on Feb. 28, 2003, now Pat. No. 7,207,147.
Application No. 10/363,999 is a continuation-in-part of application No. 10/257,992, filed on Oct. 15, 2002, now Pat. No. 7,073,301.
Application No. 10/363,999 is a continuation-in-part of application No. 09/547,206, filed on Apr. 12, 2000, now Pat. No. 6,374,552.

(51) Int. Cl. E04B 1/343; B60R 27/00

(52) U.S. Cl. 52/169.12

(57) ABSTRACT

The present invention relates to decorative and structural blocks designed to be installed as skirting structures for buildings, elevated structures and structural elements such as posts. More particularly, the present invention relates to a system that uses specifically designed and manufactured masonry blocks that are used in conjunction with specifically designed support beams and/or brackets to provide durable, attractive, easy to assemble surfaces or skirting structures. The blocks are shaped to be stacked in vertically independent, self-supporting columns, strengthened and linked together by specially shaped, lightweight, lateral support beams positioned between adjacent columns, and which may be attached directly or indirectly to a sub-structure.

### RELATED APPLICATIONS

This application is a continuation of application Ser. No. 10/395,608, filed on Mar. 24, 2003, entitled “Mortarless Wall Structure,” and published as US Publication No. 2003/0188497 on Oct. 9, 2003 which is a continuation in part of application Ser. No. 10/015,052, filed Dec. 11, 2001, entitled “Mortarless Wall Structure,” and issued as U.S. Pat. No. 6,691,471 on Feb. 17, 2004, which is a continuation in part of application Ser. No. 09/547,206, filed Apr. 12, 2000, entitled “Skirting Wall System,” and issued as U.S. Pat. No. 6,374,552 on Apr. 23, 2002. This application is also a continuation in part of application Ser. No. 10/363,999, filed Apr. 12, 2001, entitled “Mortarless Wall Structure,” and published as US Publication No. 2004/0006945 on Jan. 15, 2004, which is a continuation in part of application Ser. No. 09/547,206, filed Apr. 12, 2000, entitled “Skirting Wall System,” and issued as U.S. Pat. No. 6,374,552 on Apr. 23, 2002. This application also claims priority to PCT application Ser. No. PCT/US01/11957 filed on Apr. 12, 2001, entitled “Wall Structure,” and PCT application Ser. No. PCT/US00/25791 filed on Sep. 20, 2000, entitled “Wall Structure,” and all of which are hereby incorporated by reference.

### FIELD OF THE INVENTION

The present invention relates to decorative and structural blocks designed to be installed as exterior and interior walls for buildings. More particularly, the present invention relates to a system that uses specifically designed and manufactured masonry blocks that are used in conjunction with specifically designed support beams and/or brackets to provide durable, attractive, easy to assemble surfaces to a wide variety of buildings, structures, and structural elements.

### BACKGROUND OF THE INVENTION

Transportable structures such as mobile homes, trailer homes, modular homes and recreational vehicles, by their very nature, are usually not intended to be built upon a conventional foundation. Rather, they are brought or driven to a location where they may remain for indeterminate periods of time. Often, over an extended period at a particular site, such structures may start to settle differentially onto or in the ground due to factors such as deflating tires or local variations in soil bearing capacities.

Additionally, factors such as erosion and freeze-thaw cycles may also cause such structures to shift and/or tilt. In order to prevent such unwanted movement and ensure that a structure is level regardless of the ground's topography, the structures are often placed on stilts that extend from the structure or upon piles that extend from the ground, or even on isolated footings that distribute the weight of a structure over a relatively large surface area. While this solves the aforementioned problem of shifting/or sinking it often results in an unsightly visible gap in the area between the ground and the bottom of the structure.

Various attempts to cover the unsightly gap have included the use of plants, natural material such as rocks and wood and manmade products such as cement, masonry and plastics. These attempts have proven to be either prohibitively expensive, difficult to install and/or disassemble, or unattractive and unable to withstand sustained exposure to nature's elements. Attempts that tend to be prohibitively expensive or difficult to install include, for example, wall structures constructed of large, custom-made, cement slabs having decorative faces, and standard masonry blocks held together with mortar. Attempts that fall into the latter category include such relatively fragile and easily breakable products as wooden or plastic lattices, and synthetic panels designed to simulate stones or bricks.

Consequently, there is a need for an easy to assemble and/or dissemble, lightweight and sturdy, inexpensive wall structure for covering the gap between the ground and an elevated structure such as a mobile home.

In other applications, where brick, stone, or concrete is used as veneer or fascia, for fencing, and as load-bearing and non load-bearing walls, etc., these structures are constructed with an eye towards permanence. That is, the structures are not meant to be easily dismantled. This means that the component parts are often able to interconnect with each other and/or with a support framework in some fashion. This usually entails the use of robust connections such as mechanical fasteners, adhesives, cement, or the like. For example, many types of veneers are typically coated with adhesive or cementitious material to enable them to be securely and directly bonded to a structure. Or, as another example, walls may be constructed in a conventional manner with blocks and mortar.

Alternatively, wall structures may comprise heavy, interlocking blocks that rely on size and weight to achieve some measure of permanence. As one may well imagine, each of the aforementioned structures would be difficult and time consuming to reconfigure, remove, or repair should the need arise. And while the construction of some of these structures typically requires specialized knowledge, skills, and tools to achieve, it will be appreciated that disassembly may require other, additional specialized knowledge, skills, and tools to achieve. In light of these shortcomings, there is an additional need for a wall structure that may be easily assembled, disassembled and rebuilt or reconfigured by an unskilled user without damage to the constituent parts of the wall structure and which may be used as a veneer, fascia, cladding, fence, or as a load-bearing or non load-bearing wall.

The present invention provides a solution to these needs and other problems, and offers other advantages over the prior art.

### SUMMARY OF THE INVENTION

Generally, the present invention provides a system by which structures may be provided with durable, easy to assemble externally facing surfaces, which are generally vertical and which may be used in a wide variety of applications. The system utilizes a series of particularly configured blocks that may be operatively connected to the structures by beams and/or brackets. One embodiment of the present invention provides a block wall system for use in skirting elevated structures. The blocks are shaped to be stacked in vertically independent, self-supporting columns, strengthened and linked together by specially shaped, lightweight, lateral support beams positioned between adjacent columns, and which may be stabilized by one or more inverted u-shaped brackets which are attached at or near the bottom of an elevated structure. In an alternative embodiment, a u-shaped bracket is provided with an arm that is rotatably attached thereto and which is movable into a position that facilitates attachment to a generally vertical surface. In another embodiment, the blocks are configured so that lateral support beams may be positioned not only between adjacent columns but also at intermediate positions along the block as well. In another embodiment, the lateral support beam is configured so that it can be movably coupled to a bracket, which may be attached to an existing structure.

One embodiment of the block comprises a front face, a rear face, top and bottom surfaces, and side surfaces, and each side surface includes an outwardly opening, vertically oriented groove for receiving a portion of a support beam. The top and bottom surfaces are configured to facilitate a stacking relationship between adjacent courses of blocks such that they are generally coplanar. This relationship is most easily achieved by making the top and bottom surfaces substantially collateral, planar and relatively perpendicular to rear and/or front faces. Another embodiment of the block includes the provision of externally formed channels that are configured and arranged to prevent moisture from forming and collecting at the rear face of the block. Another embodiment of the block includes at least one through hole or aperture that is substantially aligned with outwardly opening, vertically oriented grooves in the side surfaces of a block. As will be explained later, the through holes or apertures facilitate use with support beams in a variety of applications. Another embodiment of the block has viewable surfaces or facings that are angled with respect to each other and which facilitate the formation of closed structures.

One purpose of the beams is to keep vertically stacked, self-supporting columns of blocks from buckling when subjected to a force normal to the plane of the column. This strengthening is accomplished providing the beams with lateral extensions or ribs that are configured to be received in aligned grooves at the sides of the vertically stacked blocks. Another purpose of the beams is to link adjacent columns of blocks together in a colonnade-like arrangement to form a wall structure. This is also achieved with the aforementioned lateral extensions and grooves. As may be expected, the beams provide very little, if any, support in a vertical direction. The columns so constructed are considered independent because, unlike conventionally constructed masonry or stone walls, the joints between adjacent blocks are in alignment with each other rather than being offset as in a running bond. This enables the columns of blocks to move up and down relative to each other, without appreciably altering the inherent continuity of a wall structure. As will be appreciated, the rigidity of the blocks provides enough support to prevent a column from failing in the vertical direction. When a more robust wall structure is desired, blocks that have appropriately configured apertures and rearwardly facing slots may be stacked in a running bond arrangement and strengthened and linked together by support beams. Although the beams can be fabricated form a variety of materials such as metals and plastics, extruded aluminum, nylon, and polyvinyl chloride (PVC) are preferred.

It will be appreciated that the use of the lateral support beams also eliminates and/or substantially reduces the need for mortar to stabilize and unify the blocks. This wall structure system is advantageous over traditional brick and mortar walls for obvious reasons. First, fewer materials are required to build a wall. Second, the materials are easier to handle and manipulate, and no special tools or skills are required. Third, a wall can be constructed under conditions that would not be possible using traditional brick and mortar construction and a person need not be concerned about time constraints imposed by drying mortar. Fourth, the joints formed between adjacent blocks allow the wall to appear monolithic or seamless at a surprisingly close distance. Moreover, by providing blocks that have had their marginal areas modified, it is also possible to create walls that have the appearance of conventional block and mortar construction. Fifth, the block wall system can be constructed on a variety of surfaces, including sand, gravel, dirt, or building elements such as H-beams, flooring, base blocks, etc. It is not necessary to pour a foundation.

The lateral support beams also allow the blocks to be substantially thinner than conventional masonry blocks. These thin, lightweight blocks are not only easier to handle and ship, but require less material and time to fabricate. The blocks are generally about 1 to 4 inches (2.5-10 cm.) thick, about 6 to 12 inches (15-30 cm.) in height and about 6 to 24 inches (15-60 cm.) in width, and preferably have a thickness on the order of around 2½ inches (6.0 cm.). As one may appreciate, the combination of the thin blocks and the support beams facilitates construction of masonry wall structures in locations and configurations that were heretofore not possible using thin blocks alone. The resulting wall structure of this system is surprisingly strong and it may even be used to provide support to an elevated structure. When a wall structure is installed about an elevated structure, such as a portable home, the elevated structure may be lowered onto the blocks of the wall. Alternatively, the block wall system may serve as a skirt, which improves the aesthetics of the structure and keeps animals, litter, snow, etc. from intruding or being otherwise introduced beneath the structure. Or, the block wall system may be used with existing structures such as elevated decks and retaining walls. With these embodiments, it is not necessary that the blocks make actual contact with the structure.

The block wall system also allows the wall to be easily disassembled and reassembled. This not only gives flexibility during initial construction, but also allows later renovations to be made quickly and inexpensively. For instance, it may be desirable or required to vent elevated structures having skirting walls, to prevent the buildup of moisture or condensation between the ground and the elevated structure. Such vents can be easily installed into an existing wall, especially if they are of similar dimensions and configurations as the blocks. The blocks of a given column are simply removed and reinstalled, replacing one of the blocks with the vent. Other auxiliary items, such as an access door or lights, could be installed in a similar manner.

The wall block system of the present invention is not confined to linear structures. As will be appreciated, the system also allows walls to intersect to form angled or closed structures. In one embodiment, two intersecting walls are simply aligned to form a butt joint and fasteners such as pegs, or screws, and plastic inserts are used to fasten one wall to the other. Alternatively, construction mastic, or a similar type of adhesive, may be applied instead of or in combination with the above mentioned fasteners. In another embodiment, blocks are preformed as angled intersecting wall units that have been provided with outwardly opening, vertically oriented side grooves configured to receive portions of support beams, which may be further linked to other wall blocks as described above. As will be appreciated, such blocks may be combined together to form hollow columnar structures, or may be used to clad an existing structure such as a support post. Again, ease of installation is greatly improved by the block wall system of the present invention.

Another embodiment of the wall structure uses a differently configured bracket than the aforementioned u-shaped bracket. It, too, is used to operatively connect the wall structure to a support. The bracket of this embodiment, however, attaches in a slightly different manner than the u-shaped bracket. Instead of straddling the upper portion of a top-most block as with the u-shaped bracket of the aforementioned embodiment, this bracket has one end that is configured to be positioned within space defined by opposing vertical grooves of adjacent blocks. That is, the bracket is designed to be installed at or near the sides of a column. The other end of the bracket is configured to be attached at or near the bottom of a structure. An advantage with this bracket it that it is able to provide support for the wall structure in two directions, while allowing movement of wall components relative thereto in a third direction. As will be appreciated, this bracket may be easily installed and removed without the need for special training or tools. Preferably, the bracket of this embodiment is L-shaped, although it is envisioned that other shapes are possible. For example, the bracket may be linear, or it may be linear and have an axial twist in it. Or, the structure-engaging portion may be provided with a u-shape or even its own integral fastener.

An assembly of blocks may be operatively connected to a support using yet another embodiment of the wall skirting system. With this embodiment, the support beam is configured to be movably coupled to one or more brackets that, in turn, may be attached to the support. This allows the beam to move relative to the bracket(s) without sacrificing the strength of the assembled blocks, and also allows the beams to be connected to the structure at different locations along its length. For example, at the top, at the bottom, or anywhere in between. As will be understood, in order for the support beam and bracket to operate in such a constrained manner the bracket(s) need to be configured so that they are able to slidingly retain the beam. Thus, differently configured beams may require specially configured brackets.

In another embodiment of the block wall system, blocks are operatively connected to a structure with one or more brackets, which are configured to be able to engage the side grooves of adjacent blocks, and which may be directly attached to the structure. As will be appreciated, the brackets of this embodiment will permit the blocks to move relative thereto, but not to the degree that is available with the aforementioned support beam and bracket combination. As with the aforementioned support beams, the brackets can be fabricated form a variety of materials such as metals and plastics. However, steel, extruded aluminum, nylon, and polyvinyl chloride (PVC) are preferred.

It will be appreciated that wall structures other than linear structures are possible. For example, support beams and blocks may be used to construct circular, or sinuous structures by providing curved blocks or blocks with one curved viewable surface (when viewed cross-sectionally from a point above the top surface of the block) that are operatively connected to support beams that are similarly arranged. Alternatively, a wall structure may be constructed in a zigzag or erose form with the support beams collaterally arranged relative to each other in a zigzag manner. To reduce vertical gaps between forwardly facing viewable surfaces of adjacent blocks in such a wall structure, it would be a matter of providing support beams with ribs that are angled with respect to the web and mitering or beveling the opposing sides of the blocks, or using a combination of both angling and mitering the ribs and sides, respectively. A similarly configured wall may also be constructed using support beams arranged in a coplanar or staggered fashion relative to each other and blocks having a predetermined, angular viewable surface (when viewed cross-sectionally from a point above the top surface of the blocks). For example, a “V”, “L”, or a “W”. Such blocks may have parallel front and rear faces, if desired. With such a construction, neither the support beams nor the opposing fingers need to be modified. In a related construction, it is envisioned that blocks be constructed having angles of ninety degrees so that they may be used as inner or outer corners. With such blocks, the opposing sides and their fingers would be perpendicular to each other.

In one method of constructing a freestanding, low wall structure of the present invention, a person would prepare or otherwise select an appropriate location in which to construct a wall. The construction would begin by placing a first block having opposing side grooves in a desired position and orientation. Then, a second, similar block would be placed directly on top of the first block so that the opposing side grooves of the first and second blocks are in vertical alignment with each other and the first and second blocks form a column. Next, the first and second blocks would be operatively connected to each other along their respective sides by inserting at least one rib of first and second support beams into the aligned grooves of the respective sides of the first and second blocks and seating them securely. A second column comprising similarly configured third and a fourth blocks may now be constructed. The operation is much the same, except now the third block is positioned so that one of its sides is adjacent to one of the sides of the first block and its groove engages at least one other rib of one of the already positioned support beams. The fourth block is then positioned on top of the third block in a similar manner. That is, the fourth block is positioned so that one of its sides is adjacent to one of the sides of the second block and its groove engages at least one other rib of one of the already positioned support beam. After the second column is erected, the third and fourth blocks would be operatively connected to each other along their respective free side by inserting at least one rib of a third support beam into their aligned vertical groove of the respective sides of the first and second blocks and seating them securely. And so on.

Another, alternative method of constructing a wall structure of the present invention according to the present invention would be as follows. A person would prepare or otherwise select an appropriate substructure on which to construct a wall structure. The construction would begin by operatively connecting a first elongated support beam to the substructure. Then using the first support beam as a reference, a series of additional support beams would be operatively connected to the substructure, with all of the support beams in vertical and collateral alignment, and with the distance between adjacent support beams sufficient to enable the ribs of adjacent beams to engage opposing side grooves of a block. Once the dimensions of the wall structure have been established, the blocks with opposing side grooves may be positioned by sliding the blocks along the length of and between adjacent support beams. This may be done course by course, column by column, or in a mixture of both columns and courses, as desired.

In a variation of the aforementioned methods of construction, a person would begin by operatively connecting a first elongated support beam to the substructure in a vertical orientation. Then a first block having opposing side grooves would be placed in a desired position and orientation against the first elongate support beam so that at least one of the ribs of the first beam is seated within one of the side grooves of the block. Then, a second, similar block would be placed directly on top of the first block so that the at least one rib of the first beam is also seated within one of the side grooves of the second block so that the opposing side grooves of the first and second blocks are in vertical alignment with each other and the first and second blocks form a column. Next, the first and second blocks are operatively connected to each other along their other respective sides by aligning the grooves of the respective sides of the first and second blocks, and inserting at least one rib of a second support beam into the aligned grooves and seating it securely therein. After the second support beam is seated, it is attached to the substructure. A second column comprising similarly configured third and a fourth blocks may now be constructed. The operation is the same, with the third block positioned so that one of its sides is adjacent to one of the sides of the first block and its groove engages another rib of the already positioned second support beam. The fourth block is then positioned on top of the third block in a similar manner. That is, the fourth block is positioned so that one of its sides is adjacent to one of the sides of the second block and its groove engages another rib of the already positioned second support beam. After the second column is erected, the third and fourth blocks would be operatively connected to each other along their respective free side by aligning the grooves of the respective sides of the third and fourth blocks, and inserting at least one rib of a third support beam into the aligned grooves and seating it securely therein. After the third support beam is seated, it is attached to the substructure. And so on.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is a partial, perspective view of two embodiments of the block wall system, with one preferred embodiment of blocks arranged below an elevated first (upper level) deck structure and another embodiment of blocks arranged about the perimeter of an adjacent, elevated second (lower level) deck structure;

FIG. 2 is a partial, exploded, perspective view of the block arrangement below the elevated first (upper level) deck structure of FIG. 1;

FIG. 2a is a top plan view of the block arrangement of FIG. 1, taken generally along lines 2a-2a;

FIG. 3 is a side elevational, cross-sectional view of the block arrangement about the perimeter of the elevated second (lower level) deck structure of FIG. 1 taken generally along lines 3-3;

FIG. 3a is a partial, side elevational, cross-sectional view of an alternative support for the block arrangement of FIG. 3;

FIG. 4 is a perspective view of an elevated structure skirted with an embodiment of the blocks of the present invention arranged in a wall structure;

FIG. 5 is a side elevational view the wall structure of FIG. 4 taken generally along lines 5-5;

FIG. 6 is a partial, perspective view of an embodiment of blocks arranged to provide a facia wall for a retaining wall;

FIG. 6a is a partial, side elevational, cross-sectional view of the block arrangement of FIG.6 taken generally along lines 6a-6a;

FIG. 7 is a perspective view of another embodiment of a block of the present invention;

FIG. 7a is a perspective view of another embodiment of a block of the present invention;

FIG. 7b is a bottom plan view of the block of FIG. 7a;

FIG. 8 is a partial, cross-sectional, plan view of an embodiment of a corner construction of a wall structure of the present invention;

FIG. 9 is a perspective view of another embodiment of a block of the present invention;

FIG. 10 is a bottom plan view of the block of FIG. 9;

FIG. 11 is a partial, perspective view of an embodiment of a support beam of the present invention;

FIG. 11a is a partial, perspective view of an alternative embodiment of a support beam of the present invention;

FIG. 12 is a partial, perspective view of an alternative embodiment of a support beam;

FIG. 13 is a partial, perspective view of an alternative embodiment of a support beam;

FIG. 14 is a plan view of an alternative embodiment of a block engagement portion of a vertical support beam similar to that of FIG. 11a, with the remainder of the support beam shown in phantom;

FIG. 15 is a plan view of an alternative embodiment of a block engagement portion of a support beam similar to that of FIG. 11a, with the remainder of the support beam shown in phantom;

FIG. 16 is a partial, perspective view of an embodiment of a support beam of the present invention;

FIG. 17 is a partial, perspective view of another embodiment of a support beam in conjunction with a bracket, with the bracket configured to be attached to a sub structure;

FIG. 18 is a partial, perspective view of another embodiment of a support beam in conjunction with another embodiment of a bracket, with the bracket configured to be attached to a sub structure;

FIG. 19 is a partial, perspective view of another embodiment of a support beam in conjunction with another embodiment of a bracket with the bracket configured to be attached to a substructure;

FIG. 20 is a partial, perspective view of an embodiment of a support beam having an integrally formed aperture and an integrally formed bracket, with the support beam able to be used with the support beam of FIG. 19 to construct/form a double sided wall structure;

FIG. 21 a partial, perspective view of another embodiment of a support beam;

FIG. 22 is a partial, top plan view, taken generally along lines 22-22 of FIG. 4, of showing adjacent blocks of the present invention in conjunction with a support beam;

FIG. 23 is a partial, top plan view of the two blocks abutted with a support beam of FIG. 22, but with the support beam arranged in an alternative configuration;

FIG. 23a is a partial, top plan view of the blocks of FIG. 23 as they may be assembled into a wall structure, or as a wall structure is disassembled;

FIG. 24 is a partial, top plan view of two blocks, a support beam, and a support bracket that have been assembled into a wall structure;

FIG. 24a is a partial, top plan view of a portion of the blocks, support beam, and bracket of FIG. 24, as they may be assembled into a wall structure, or as a wall structure is disassembled;

FIG. 25 is a partial, top plan view of two blocks of the present invention in conjunction with an alternative embodiment of a support beam;

FIG. 26 is a partial, top plan view of two blocks of the present invention in conjunction with another alternative embodiment of a support beam;

FIG. 27 is a partial, top plan view of the support beams shown in FIGS. 12 and 13 in conjunction with blocks of the present invention;

FIG. 28 is a partial, top plan view of two blocks of FIG. 7a that are operatively connected to the support beam of FIG. 11a;

FIG. 29 is a partial, top plan view of the support beam of FIG. 16 as it may be used to operatively connect blocks of the present invention to a substructure;

FIG. 30 is a perspective view of a wall structure construction using another preferred embodiment of support beams and blocks of the present invention;

FIG. 31 is a partial, top plan view of the support beam and bracket of FIG. 17 as they may be used to operatively connect blocks to a substructure;

FIG. 32 is a partial, top plan view of the support beam and bracket of FIG. 18 as they may be used to operatively connect blocks to a substructure;

FIG. 33 is a partial, top plan view of the support beam and bracket of FIG. 19 as they may be used to operatively connect blocks to a substructure;

FIG. 34 is a partial, top plan view of an alternative embodiment of the support beam of FIG. 21 as it may be used to operatively connect blocks to a substructure;

FIG. 35 is a partial, top plan view of the support beam of FIG. 21 as it may be used to operatively connect blocks to a substructure;

FIG. 36 is a partial, top plan view of the support beam of FIG. 20 and the support beam of FIG. 19 as they may be used to operatively connect differently sized blocks together in a dual-sided wall structure;

FIG. 37 is a partial, top plan view of the blocks of FIG. 7 in conjunction with another embodiment of a support beam, with the support beam operatively connecting the blocks to an existing structure;

FIG. 37a is a partial, top plan view of the blocks of FIG. 7 in conjunction with another alternative embodiment of a support beam with the support beam operatively connecting the blocks to an existing structure;

FIG. 37b is a partial, top plan view of blocks of FIG. 7 in conjunction with another alternative embodiment of a support beam with the support beam operatively connecting the blocks to an existing structure;

FIG. 38 is a partial, top plan view of a free standing dual wall structure wherein the respective walls of the wall structure are connected to each other in a spaced relation by an alternative embodiment of a support beam;

FIG. 39 is a partial, top plan view of blocks of FIG. 7 in conjunction with an alternative embodiment of the support beam of FIG. 20, wherein the aperture is configured to received a post;

FIG. 40 is a partial, perspective view of an embodiment of a wall structure of the present invention and a preferred attachment bracket;

FIG. 41 is a perspective view of the attachment bracket of FIG. 40;

FIG. 42 is a side elevational view of the bracket of FIG. 41 attached to a lower surface of a structure, and as it may be attached to an upper surface of the structure (shown in phantom);

FIG. 43 is a perspective view if the attachment bracket of FIG. 41 as it may be used in conjunction with the support beam of FIG. 11;

FIG. 44 is an exploded, perspective view of an attachment bracket and the support beam of FIG. 11a;

FIG. 45 is a rear perspective view of the attachment bracket and support beam of FIG. 44 after they have been operatively connected to each other;

FIG. 46 is a perspective view of an alternative embodiment of an attachment bracket suitable for use with a support beam as depicted in FIG. 11a;

FIG. 47 is a plan view of the attachment bracket of FIG. 46 as it may be operatively connected to a support beam as depicted in FIG. 11a;

FIG. 48 is a perspective view of an alternative embodiment of an attachment bracket having an arm that is rotatably connected thereto, and which is in a first position;

FIG. 49 is a perspective view of the attachment bracket of FIG. 48 in which the arm has been rotated to a second position;

FIG. 50 is a perspective view of an embodiment of an attachment bracket;

FIG. 51 is a partial, perspective view of a wall structure in which blocks of the present invention are operatively connected to a substructure by the vertically oriented support beams and brackets of FIGS. 2 and 2a;

FIG. 52 is another partial perspective view of a wall structure in which blocks of the present invention are operatively connected to a substructure by horizontally oriented support beams and brackets of FIGS. 2 and 2a;

FIG. 53 is a side elevation view of a block wall structure that is operatively connected to a structure;

FIG. 54 is an edge view of a sealing element that is used in the construction of the wall structure of FIG. 53;

FIG. 55 is a perspective view of the sealing element of FIG. 54;

FIG. 56 is an enlarged view of a portion of FIG. 53, which depicts the sealing element of FIGS. 54 and 55 as it resides between structural elements;

FIG. 57 is a perspective view of an alternative embodiment of an attachment bracket for use in conjunction with blocks of the present invention;

FIG. 58 is a perspective view of an alternative embodiment of an attachment bracket for use in conjunction with blocks of the present invention;

FIG. 59 is a perspective view of an alternative embodiment of an attachment bracket for use in conjunction with blocks of the present invention; and,

FIG. 60 is a plan view of the brackets of FIGS. 57 and 59 operatively connecting blocks of the present invention to a substructure.

### DETAILED DESCRIPTION

FIG. 1 illustrates several embodiments of the wall block system of present invention, as practiced with an elevated first (upper level) deck d1 and an adjacent, elevated second (lower level) deck structure d2. The first embodiment is an elevated upper level deck structure d1, which is supported by a plurality of vertical posts that have been provided with an external sheathing of blocks that are operatively connected to the posts by support beams and brackets.

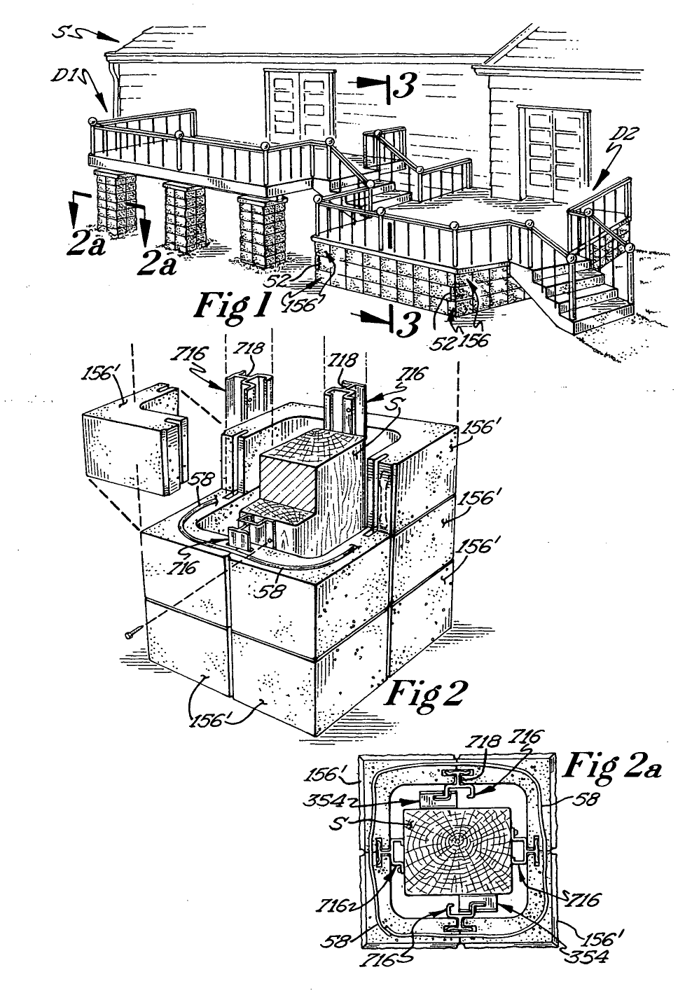

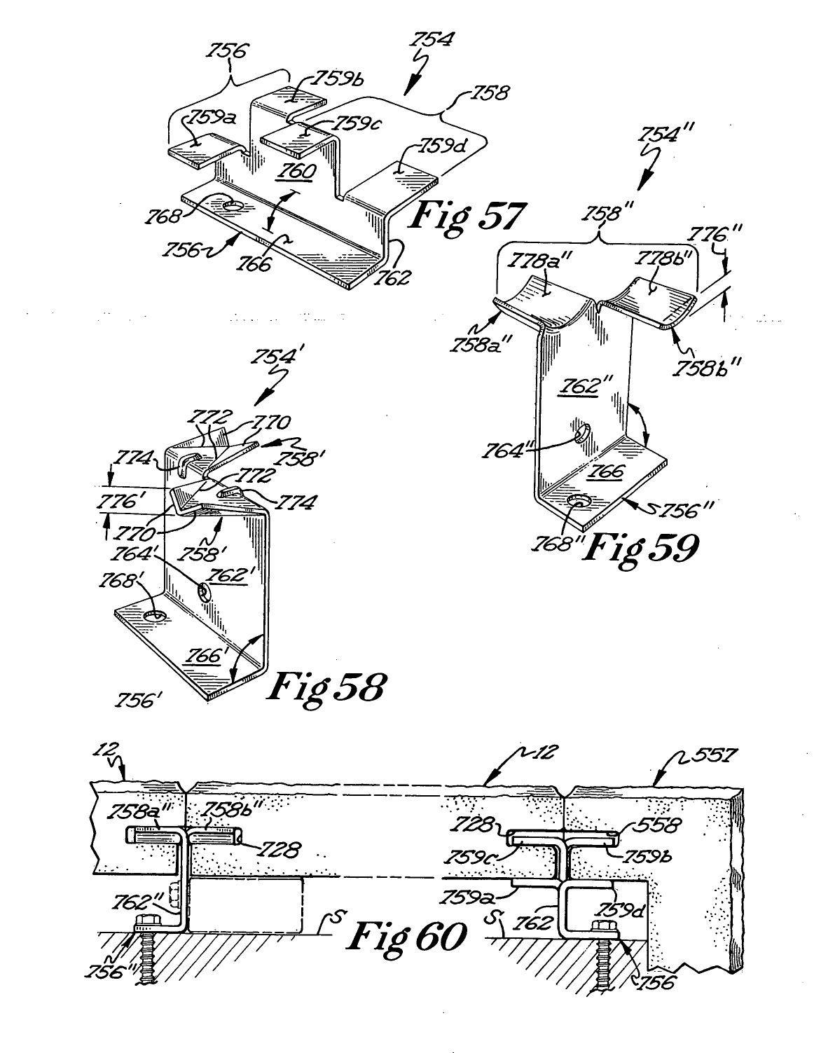

As depicted, the blocks used to sheath the post are angled blocks, such as depicted in FIGS. 2 and 2a. The blocks, which are provided with grooves at their side edges, are configured to be operatively connected to a post by one or more support beams 716, which will be discussed later in greater detail. As depicted, the support beams may be directly attached to the post. Alternatively, the blocks may also be operatively connected to the post by a support beam and a bracket 354 (see, for example, FIG. 2a, which will be discussed later in greater detail), or by brackets alone (see FIGS. 57, 58, 59 and 60). While it will be understood that a post sheathing will be relatively robust, it may be desirable to create a more permanent structure. This can be achieved, for example, by providing the horizontal and/or vertical edge surfaces of the blocks with a suitable adhesive 58 (vertical edge surfaces shown in phantom). Alternatively, the blocks may be secured by one or more circumferential bands of material (not shown).

Referring again to FIGS. 1, 2 and 2a, it will be apparent that gaps may exist between the blocks and the post, and that moisture and debris may infiltrate the gaps from above, and/or between the joints between adjacent blocks. As will be understood, such infiltration may be substantially reduced by providing the sheathed post with cap stones, flashing gaskets or other construction elements that serve to effectively close the gaps from above. Infiltration reduction may also be achieved by providing the horizontal and vertical edge surfaces with caulking material.

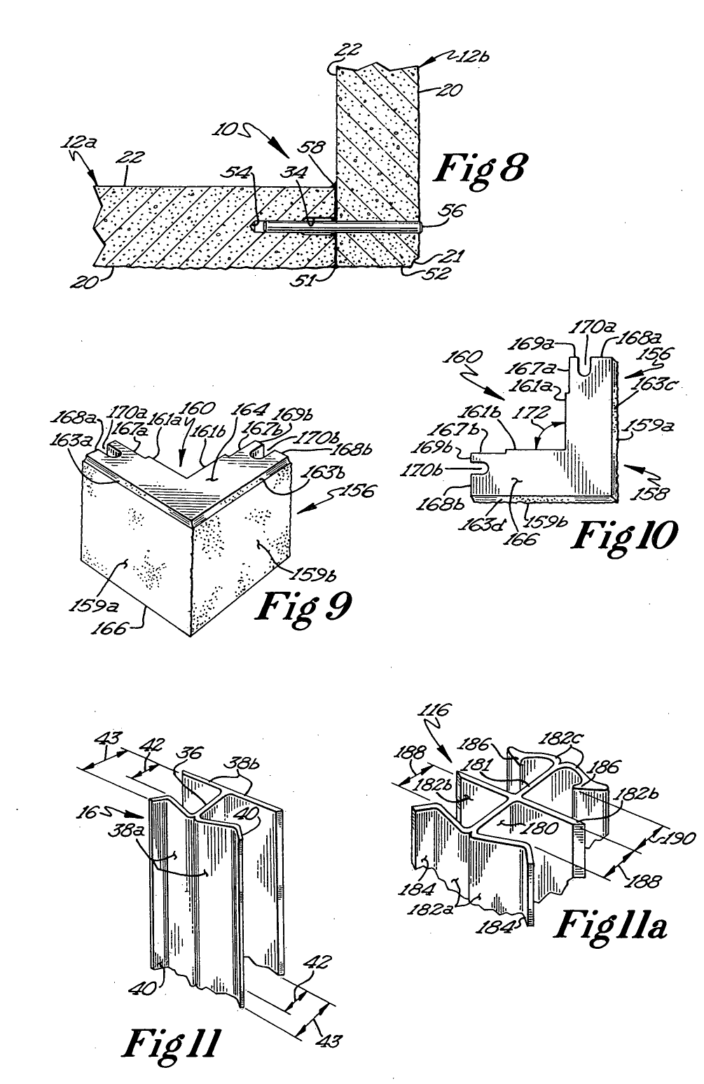

The second embodiment of the block wall system of FIG. 1 depicts another application of the present invention, where blocks are used to skirt an elevated, lower level, second deck structure d2. In this application, the wall structure comprises several block embodiments. Starting from the left corner, the upper and lowermost courses comprise blocks that are similar to the corner blocks of FIGS. 2 and 2a. The middle course, while it could comprise a block of FIGS. 2 and 2a, is constructed using two linear blocks that are connected to each other by fastening element such as pins and/or adhesive material (see, for example, FIG. 8). Continuing towards the right, the next block embodiments, which will be discussed later in greater detail, are generally linear and as will be discussed later, configured to be operatively connected to the deck frame. Continuing on to the right corner, the arrangement of the blocks is similar to the arrangement of the blocks depicted at the left corner. The right corner differs, however, in that the corners formed by the blocks are not ninety degrees. Instead, the corner formed by the intersection of two walls is obtuse.

As will be discussed later in greater detail, the skirting structure blocks may be operatively connected to the deck frame in a manner similar to the previously discussed post sheathing. That is, through the use of support beams, support beams and bracket, or brackets. The wall structure depicted in FIG. 5 uses a support beam that is attached directly to the deck frame. As will be discussed later, the support beam serves to maintain and align a plurality of blocks. As depicted, the blocks of FIG. 5 are supported by a longitudinal L-shaped support bar that is also attached to the deck frame. With this operative connection, the blocks are not subject to external forces such as frost heave, and are generally static.

In the partial depiction wall structure of FIG. 5a, the support beam is indirectly connected to the deck frame by one or more brackets. In this instance, the beam and bracket combination is similar to the beam and bracket combination of FIG. 2a. This combination allows the beam (and blocks), which rest on a footing, to move in response to external forces such as frost heave. In this regard, the operative connection can be considered dynamic.

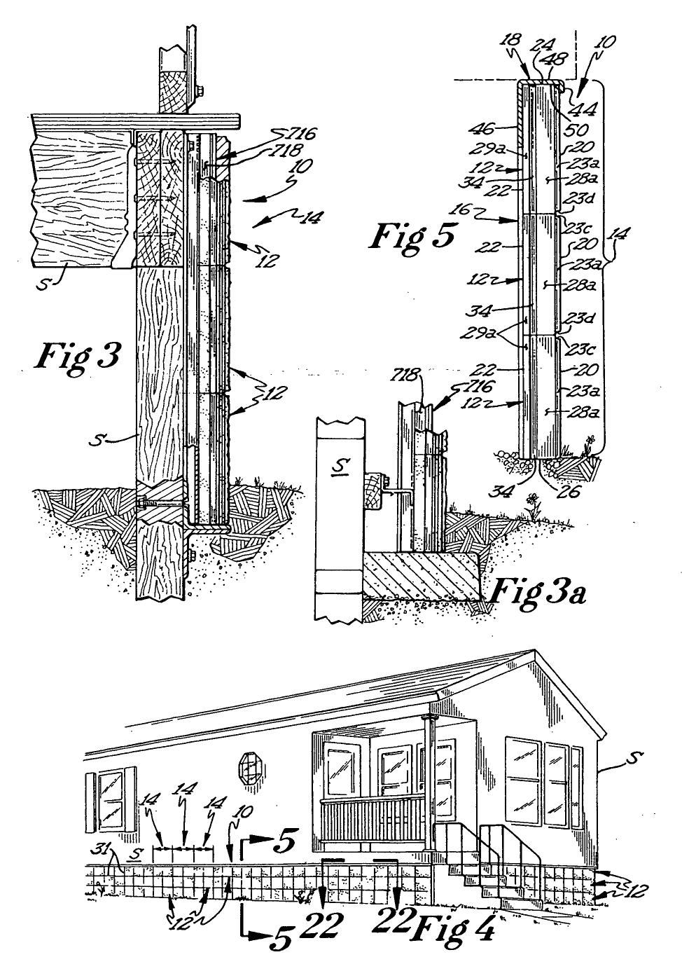

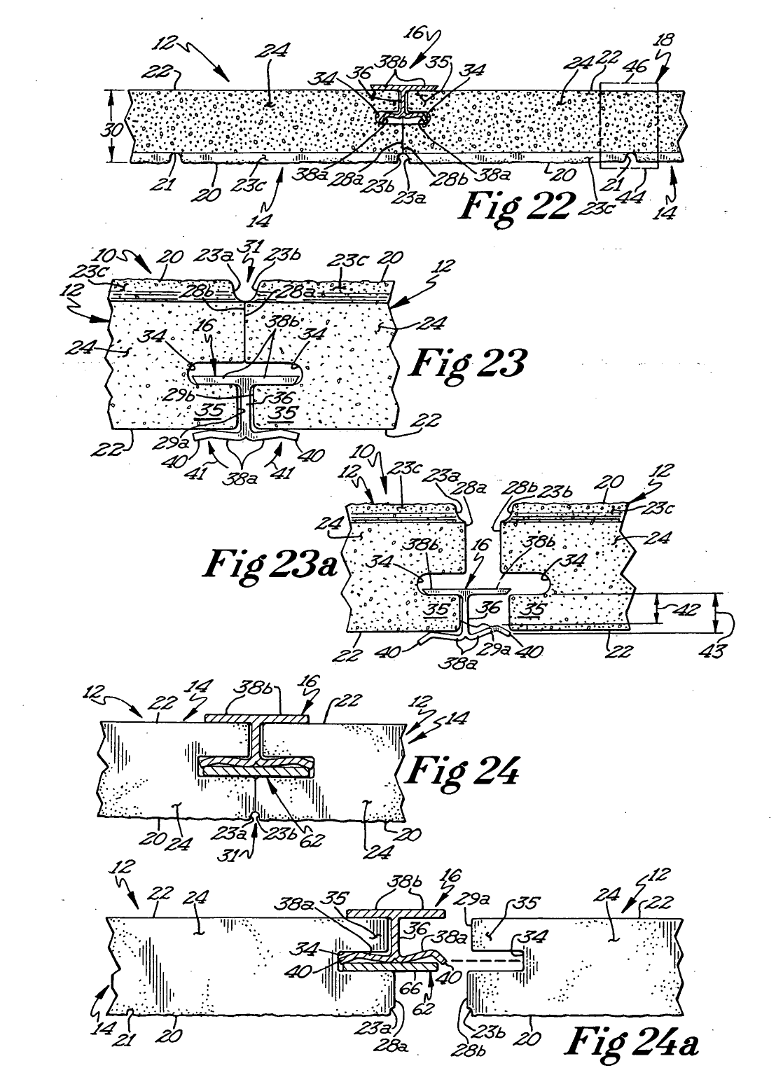

FIG. 3 is a perspective view of an elevated structure “S” skirted with a wall system 10 of the present invention. Generally, the wall structure 10 comprises of a plurality of blocks 12 forming columns 14 (see also, FIG. 4) partially spaced apart and held in place by vertically oriented, lateral support beams (see, for example, FIGS. 5, 11, 22, and 23). Downward opening brackets 18 (see FIGS. 5 and 22) that are attached to the bottom of the structure “S” being skirted, are configured to engaged the top block 12 of selected columns 14 to help prevent the wall structure 10 from tipping rearwardly or forwardly. As used herein, the term “forward” means away from the center of the elevated structure “S” and the term “rearward” means toward the center of the elevated structure “S”.

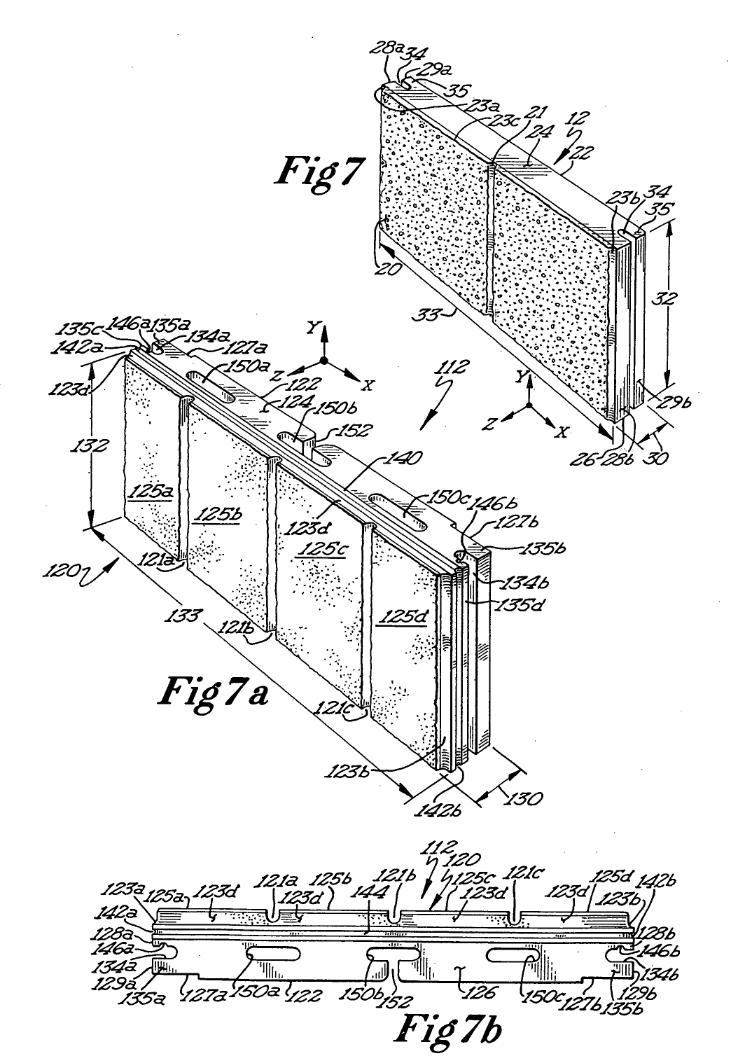

FIGS. 4 and 7 show an arrangement of blocks 12 that form a plurality of columns 14. Referring particularly to FIG. 7, each block 12 is generally panel-shaped and includes a front face 20, a rear face 22, a top surface 24, a bottom surface 26 and pairs of side surfaces 28a, 29a and 28b, 29b, respectively. The side surface pairs 28a, 29a and 28b, 29b, respectively, are preferably somewhat perpendicular to the rear face 22 and/or the front face 20. Side surface 28a is spaced from side surface 28b by a distance (taken along a “x” direction in a three-dimensional coordinate system relative to the blocks 12) to define a width 33 of the block 12. Additionally, each pair of side surfaces 28a and 29a, 28b and 29b, include a substantially vertical groove 34 therebetween, which is configured to receive a portion of a lateral support beam 16 (See, for example, FIG. 11).

Note that while the top and bottom surfaces 24, 26 of adjacent blocks 12 are configured to contact each other without thick layers of mortar or binding material therebetween, it is envisioned that the use of thin layers of intermediate materials, which may serve to strengthen and/or provide resistance to moisture may be practiced without departing from the spirit and scope of the invention. Moreover, it will be apparent that thin or no intermediate layers will minimize the spacing between blocks and allow the marginal areas 23c, 23d of adjacent blocks 12 to combine and simulate horizontally oriented splitting recesses.

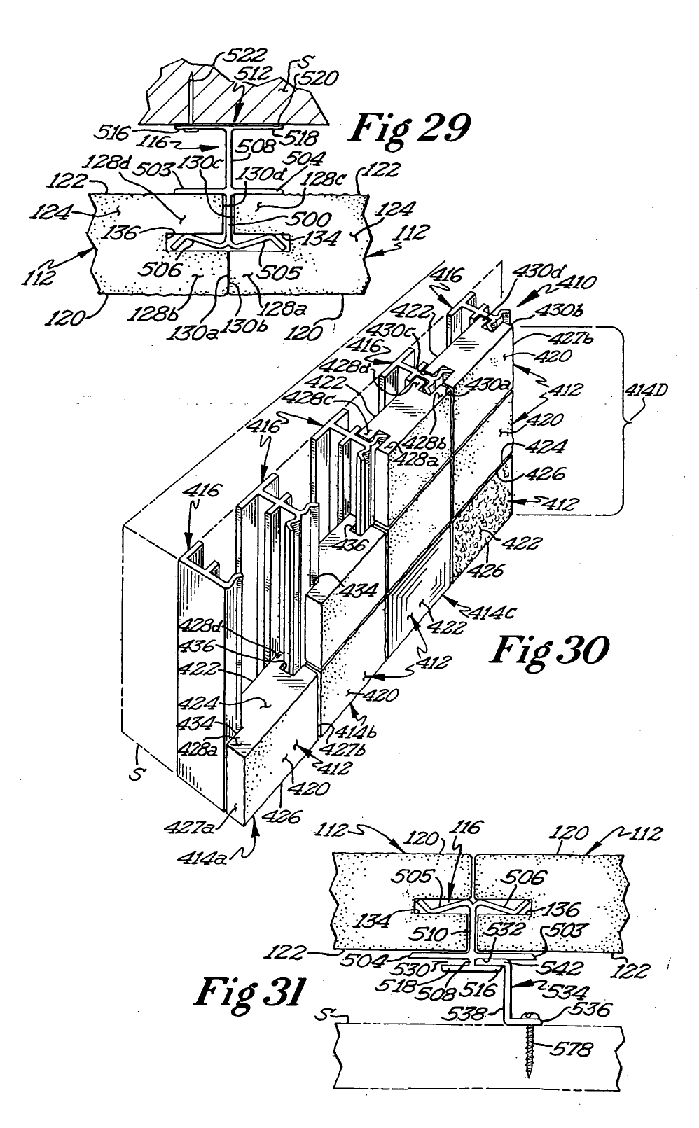

As will be understood, the brackets 18 (see FIGS. 4 and 22) prevent rearward or forward movement of the column 14 and also work in conjunction with the beam 16 to prevent columns 14 not in direct contact with the bracket 18 from tipping over rearwardly or forwardly. It is envisioned that the beams 16 may be directly attached to the wall structure 10 (similar to FIG. 29) or alternatively, the bracket 18 may be solely responsible for preventing the wall structure 10 from tipping over. While it will be understood that the bracket 18 can be of any suitable material, synthetic, more preferably poly-vinyl chloride (PVC) or other durable plastic is preferred.

The bracket 18 comprises a front wall 44, a rear wall 46 spaced apart from front wall 44 and a top wall 48 joining the front wall 44 to the rear wall 46 in a generally inverted “U”-shape. The front wall 44 and the rear wall 46 define an opening 50, which is configured and arranged to receive an uppermost portion of the top block 12 of a column 14. In practice, the bracket 18 is attached at or near the underside of a structure “S” to be skirted so that the opening 50 can receive the upper portion of the top block 12 of a column 14. Preferably, the bracket 18 is positioned such that it may straddle the central region of an uppermost block 12. It may be desired to make rear wall 46 of a greater vertical dimension than the front wall 44 to provide additional support. It may also be desired to provide a bracket 18 with a rear wall 46, width that extends in a lateral direction further than the front wall 44 width. Furthermore, it is envisioned that the bracket 18 can be formed into a variety of lengths. For instance, the bracket 18 can be as short as one inch or as long as the entire skirted structure “S”.

While the top wall 48 of the bracket 18 is depicted in FIG. 4 as being in contact with the top surface 24 of the uppermost block 12 of the column 14, it should be understood that this need not always be the case. In situations where the wall structure 10 is not a load bearing wall, or where the terrain shifts or changes due to climate, settling, animals, roots, etc., it may be desirable to provide a gap between the top wall 48 and the top surface of the wall structure 10. Thus, individual columns 14 will be able to move vertically in small increments without destroying the integrity of the wall structure 10 or the skirted structure (not shown). In that regard, it should be appreciated that the beams 16 slidingly grip portions of the blocks 12. That is to say, the beams 16 do not grip the blocks 12 with so much force as to preclude relative movement of the blocks 12 therealong in a longitudinal direction.

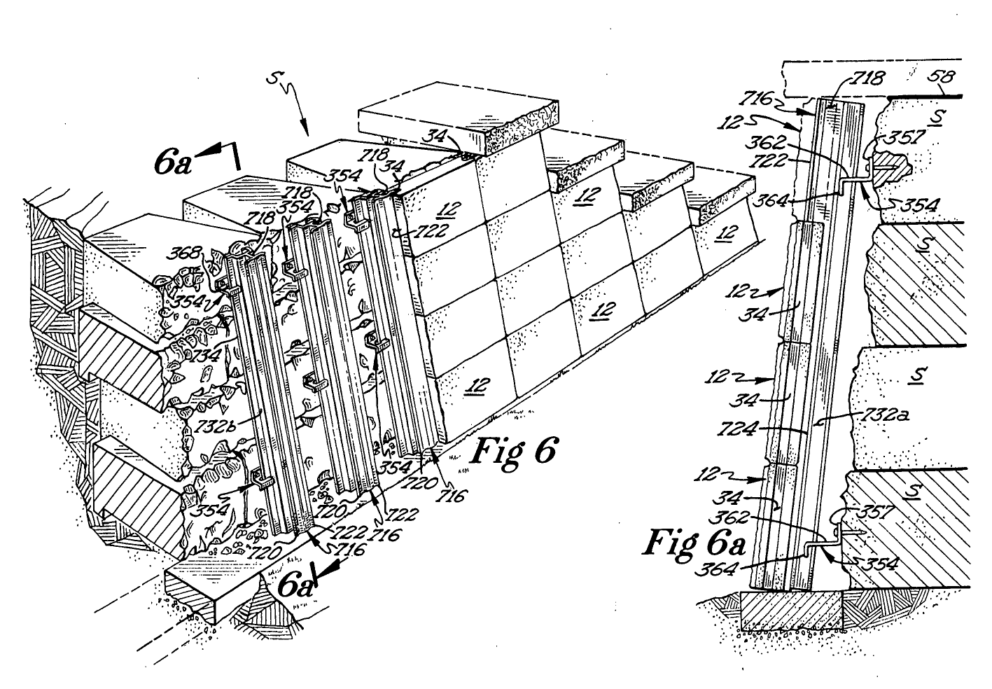

FIGS. 6 and 6a show an embodiment of another application of the present invention, where blocks are used to provide a facia wall in front of an existing retaining wall. The facia wall is formed using support beams and brackets similar to the beams and brackets depicted in FIGS. 2 and 2a. That is, the support beam 716, as shown, comprises an elongated spine or web 718 and plurality of ribs 720 and 722, 724 and 726, which are arranged in a substantially coplanar and collateral relation so that the first pair of ribs 720, 722, which are substantially coplanar and extend away from each other. The first pair of ribs 720, 722 are designed to engage the grooves of one or more blocks of a structure (see, for example, FIG. 6a).

In addition, the web 718 also includes a second pair of ribs 724, 726, which are also substantially coplanar and which extend away from each other. Note that the pairs of ribs 724 and 726 are in substantially collateral or parallel relation with respect to each other and are spaced apart from each other by a distance defined by the web 718. As better shown in FIGS. 51 and 52, he support beam 716 also includes a pair of pair of leg structures 730 having leg portions 732a, 732b that they extend rearwardly away from ribs 724, 726 and which form a generally U-shaped channel therewith. One of the leg portions 732b includes a foot 734. that extends laterally away from the leg portion 732b and is generally parallel with ribs 724, 726. As with the embodiment of FIGS. 2 and 2a, the foot may be connected directly or indirectly to a support structure. However, as depicted, the beams of FIGS. 6 and 6a are operatively connected to a structure by a plurality of brackets 354, which are attached to blocks of the retaining wall. With such an arrangement the beams, which are slidingly constrained by the brackets, permit blocks to move without destroying the integrity of the structure.

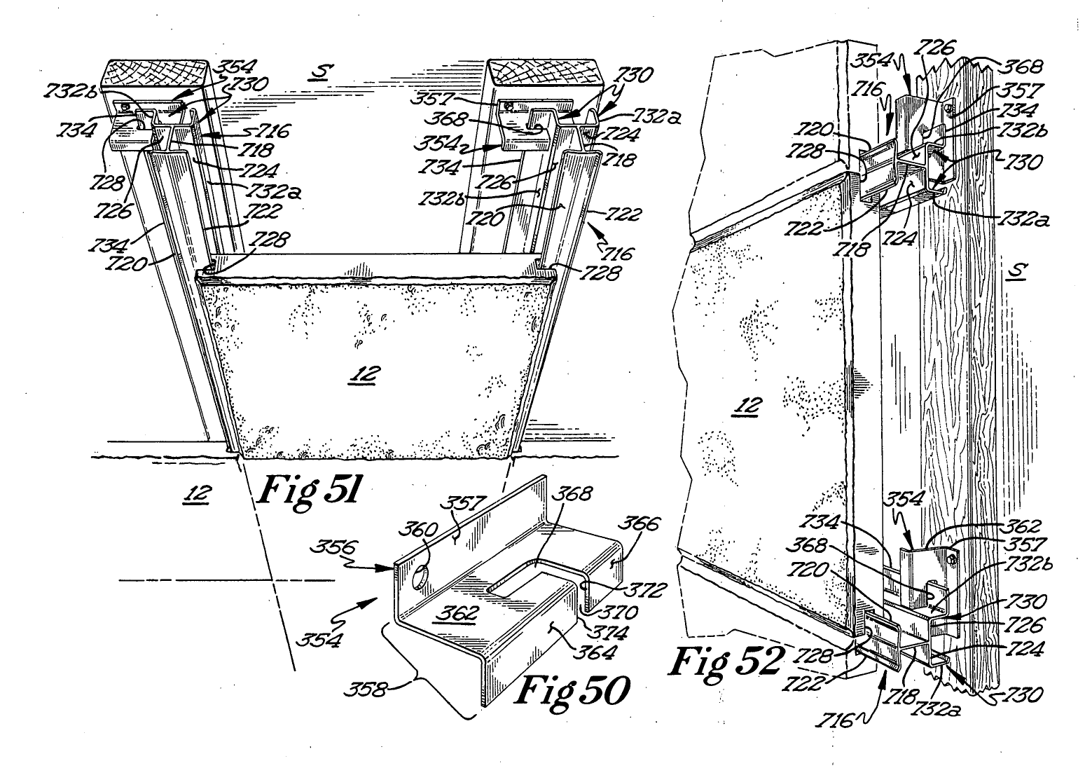

The brackets 354 used to operatively connect the beams 718 to the retaining wall blocks generally comprise a structure engaging portion, a web, and a support beam engaging portion. As shown in FIG. 50, the structure engaging portion 356 of bracket 354 comprises a single or first member 357 that is provided with an aperture 360, which is used to facilitate attachment to the retaining wall with fastening elements such as nails, threaded fasteners, or anchor bolts. It will be appreciated, however, that an aperture or apertures need not be present in order to attach the bracket to a structure. The fastening element(s) may be driven through the first member, if desired. Additionally, it will also be appreciated that attachment may also be achieved with suitable adhesives, in lieu of, or in addition to, fastening elements. The support beam engaging portion 358 comprises a web 362 and a pair of legs 364, 366, which are angled with respect to the web to form a generally “L”-shape. The web 362 includes an aperture 368 that is accessible through a slot 370 defined by edges 372 and 374 of legs 366 and 364, respectively. The aperture 368 and slot 370 are configured to slidingly receive a leg portion 732b and foot 734 of a support beam (see also, FIGS. 50, 51 and 52).

Attention is now directed to the individual components of a wall structure 10. FIG. 7 depicts a preferred embodiment of a block 12. It can be seen that the block 12 is generally panel-shaped and includes a front face 20, a rear face 22, a top surface 24, a bottom surface 26 and pairs of side surfaces 28a, 29a and 28b, 29b, respectively. The block 12 is preferably made of a composite masonry material in a dry-cast molding operation. Though the general shape of the blocks 12 is more important than the material used in order to practice the present invention, composite masonry material provides the most desirable combination of strength, appearance, economy, and ease of manufacturing. It is envisioned, however, that other materials can be used, such as concrete, fiberglass, ceramics, hard plastics, dense foam, or even wood.

The front face 20 is spaced from the rear face 22 by a predetermined distance herein defining the thickness or depth 30 (generally about 1 to 4 inches (2.5 to 10.0 cm)) of the block 12. As shown in FIG. 7, the front face 20 is formed to have a roughened or rustic surface. Such surfaces commonly result during block fabrication, where a mold is cast and the casting is later split or fractured into two blocks along a predetermined plane, with the plane of separation between the two blocks defining a pair of opposing front faces. Splitting is not necessary to carry out the spirit of the invention, however, and the block 12 may be formed by other known methods. Moreover, the front face 20 can be dressed, modified, or otherwise worked in any desired manner.

A vertically oriented splitting recess 21 may be provided on the front face 20 of the block 12 to enable the block 12 to be fashioned into predetermined shapes. In FIG. 7, the splitting recess 21 is depicted as bisecting the block 12. However, it is understood that the splitting recess can be located and oriented elsewhere on the block. That is, the splitting recess can be off-center, horizontal, diagonal, etc. Moreover, it is also understood that the block can be provided with more than one splitting recess, if desired.

The front face 20 includes marginal areas 23a, 23b, 23c, and 23d. As may be expected, the number of marginal areas corresponds to the number of edges of the front face 20. These marginal areas may be worked or modified, if desired, to produce different visual effects. Here, the desired effect is for the marginal areas 23a, 23b, 23c, and 23d to simulate splitting recesses 21. Thus, the marginal areas 23a, 23b, 23c, and 23d are formed so that when blocks 12 are positioned in contact with each other in a wall structure 10, the cross-sectional profiles of their marginal areas 23a, 23b, 23c, and 23d, when combined, simulate splitting recesses 21. As depicted the splitting recesses 21 have a cross-sectional profile that is somewhat circular, and the marginal areas 23a, 23b, 23c, and 23d have cross-sectional areas that are fluted or arced. As can be appreciated, the splitting recesses 21 and marginal areas 23a, 23b, 23c, and 23d may be configured with other cross-sectional profiles, if desired. For example, a “V”-shaped cross-sectional profile.

As mentioned above, tight or thin joints 31 (See FIG. 3) between adjacent blocks 12 enables a wall structure to appear monolithic or seamless. This feature may be used in combination with splitting recesses 21 and marginal areas 23a-d of the blocks 12 to create different visual effects. For example, it is envisioned that a wall structure may simulate running bonds by having the blocks of each column alternate between a block with no splitting recess and worked marginal areas and a block having a splitting recess and worked horizontal marginal areas (see, for example, FIG. 40). Or, it is envisioned that the splitting recesses and marginal areas be selected to enable the wall structure to simulate an ashlar block wall (not shown).

Referring again to FIG. 7, the top surface 24 is spaced from the bottom surface 26 by a distance (taken along a “y” direction in a three-dimensional coordinate system relative to the block 12) to define the height 32 (about 6 to 12 inches (15 to 30 cm)) of the block 12. When blocks 12 are arranged vertically to form a column 14 (see FIG. 4), the bottom surface 26 of any block 12 other than the bottom block of a column 14 (not shown) rests on the top surface 24 of the block therebelow. It is therefore preferred that the top surface 24 and the bottom surface 26 be configured to facilitate a stacking relationship between two blocks 12. A stacking relationship is most easily achieved by making the top and bottom surfaces 24, 26 substantially collateral, planar, and relatively perpendicular to the rear face 22 and/or the front face 20, as best shown in FIGS. 4 and 5. Alternatively, it is envisioned that top and bottom surfaces 24, 26 may be complementarily shaped, and not perpendicular to the rear face and/or the front face, but which permit upper and lower blocks to be stacked in a vertical relationship (not shown). For example, the surfaces could be non-planar and/or irregular. Alternatively, the surfaces can have compound curves or even interlocking segments (not shown).

The side surface pairs 28a, 29a and 28b, 29b, respectively, are preferably somewhat perpendicular to the rear face 22 and/or the front face 20. Side surface 28a is spaced from side surface 28b by a distance (taken along a “x” direction in a three-dimensional coordinate system relative to a block 12) to define the width 33 (6 to 24 inches (15 to 60 cm)) of block 12. Additionally, each pair of side surfaces 28a and 29a, 28b and 29b, include a substantially vertical groove 34 therebetween that is configured to receive a portion of a lateral support beam 16 (see, for example, FIG. 11). While a pair of side grooves for each block is preferred, it is envisioned that one side surface be provided with a groove and the other side surface have a tongue configured to mate with the groove, thereby obviating the need for beams 16. However, in order to maintain the vertically independent characteristics of columns 14, the use of beams 16 is preferred.

Referring now to FIGS. 7a and 7b, another embodiment of the block of the present invention is depicted. The block 112 is generally panel-shaped and includes a front face 120, a rear face 122, a top surface 124, a bottom surface 126 and pairs of side surfaces 128a, 129a, and 128b, 129b, respectively.

The front face 120 is spaced from the rear face 122 by a predetermined distance defining the thickness or depth 130 (generally about 1 to 4 inches (2.5 to 10.0 cm)) of the block 112. As shown in FIG. 7a, the front face 120 is formed to having a roughened or weathered surface. However, it is understood that the front face 120 could, be dressed, modified, or otherwise worked in any desired manner.

Vertically oriented splitting recesses may be provided on the front face of the block to enable the block to be fashioned into predetermined shapes. Here, the splitting recesses 121 are depicted as quartering the block 112 and forming front face segments 125a, 125b, 125c, and 125d. However, it is understood that the splitting recesses 121 may be located and oriented elsewhere on the block 112. That is, the splitting recesses 121 could be off center, horizontal, diagonal, etc. Moreover, it is also understood that a block splitting recesses 121 may be omitted, if desired.

The front face 120 includes marginal areas 123a, 123b, 123c, and 123d. As may be expected, the number of marginal areas corresponds to the number of edges of the front face 120. The marginal areas 123a-d may be worked or modified, if desired, to produce different visual effects. In FIG. 7a, the desired visual effect is for the marginal areas to simulate splitting recesses. Thus, the marginal areas 123a-d are formed so that when blocks 112 are positioned in contact with each other in a wall structure 10 (See FIG. 3, for example), the cross-sectional profiles of their marginal areas 123a-d, when combined, simulate splitting recesses at the joints formed by the block. As depicted, the splitting recesses 121 have a cross-sectional profile that is somewhat circular, and the marginal areas 123a-d have cross-sectional areas that are fluted or arced. As can be appreciated, the splitting recesses and marginal areas 123a-d may be configured with other cross-sectional profiles, if desired. For example, a “V”-shaped cross-sectional profile.

Referring again to FIG. 7a, the top surface 124 is spaced from the bottom surface 126 by a distance (taken along a “y” direction in a three-dimensional coordinate system relative to the block 112) to define the height 132 (about 6 to 12 inches (15 to 30 cm)) of the block 112. When the blocks 112 are arranged vertically to form a column 14 (see, for example, FIGS. 4 and 5), the bottom surface 126 (not shown) of any block 112 other than the bottom block of a column 14 (See FIG. 5) rests on the top surface 124 of the block 112 therebelow. It is therefore preferred that the top surface 124 and the bottom surface 126 be configured to facilitate a stacking relationship between two blocks 112. A stacking relationship is most easily achieved by making the top and bottom surfaces 124, 126 substantially collateral, planar and relatively perpendicular to the rear face 122 and/or the front face 120, as shown in FIGS. 4 and 5. Alternatively, it is envisioned that the top surface 124 and the bottom surface 126 (see FIG. 7b) may be complementarily shaped, and not perpendicular to the rear face 122 and/or the front face 120, as long as the upper and lower blocks 112 can be stacked in a vertical relationship. For example, the surfaces 124, 126 (not shown) can be non-planar and/or irregular. Or, the surfaces 124, 126 (not shown) can have compound curves or interlocking segments (not shown).

Referring to FIG. 7b, the side surface pairs 128a, 129a and 128b, 129b, respectively, are preferably somewhat perpendicular to the rear face 122 and/or the front face 120. The side surface 128a is spaced from the side surface 128b by a distance (taken along the “x” direction in a three-dimensional coordinate system relative to the block 112) to define the width 133 (6 to 24 inches (15 to 60 cm)) of the block 112. Additionally, each pair of side surfaces 128a, 129a, 128b and 129b, include a substantially vertical groove 134 located therebetween that is configured to receive a portion of a lateral support beam (see, for example, the lateral support beam depicted in FIGS. 11, and 23-36).

The block 112 is that it is additionally provided with one or more substantially vertical apertures or through holes 150a, 150b, and 150c. As can be seen, apertures 150a, 150b, and 150c, which are in substantial alignment with the grooves 134 located on either side of the block 112. This enables for use with support beams 270 such as those shown in (See FIG. 12), to be used, if desired. The vertical apertures 150a-c also allow a plurality of blocks 112 to be positioned in a running bond (again using support beams 270 such as those shown in FIG. 12, for example). The aperture 150b may be provided with a slot 152, which that provides an opening to the rear face 122. In addition, the block 112 may now be split into smaller predetermined sizes, with each smaller block (not shown) having a set of side grooves 134. Although not depicted, it will be understood that apertures 150a and 150c may also be provided with slots (as with aperture 150b), if desired.

Another feature of block 112 is the provision of recesses 127a and 127b on the rear surface 122 adjacent the side surfaces 129a and 129b. The recesses come into play during, and aid in, the manufacturing of the block. After a large block (not shown) is molded and split into two smaller blocks and the smaller blocks are removed from the conveyor on which they rest by a pusher bar (not shown) that impacts the rear surfaces of the blocks and moves them in a desired direction. This works if the blocks are substantially parallel to the pusher bar. However, if the blocks are not substantially parallel to the pusher bar, the bar has a tendency to chip and break the side segments. The recesses provide clearance so that if the block is somewhat askew relative to the pusher bar, the bar will not contact the side segments and thereby reducing chipping and breakage.

FIG. 8 shows a preferred corner configuration using the blocks 12 of the present invention. The design of the block 12 lends itself to the formation of corners without the need for mortar, corner braces, or other supports. Two blocks 12a and 12b are simply aligned to form a corner butt joint 51. Preferably, block 12b is broken along its splitting recess to form a new split face, which roughly matches split front face of block 12a. Holes 54 are drilled through the blocks 12a and 12b so that a fastener 56 may be inserted therein. Generally, the fastener may be any suitable fastener, and preferably, an appropriately sized pin, peg, or screw, and the like. Alternatively, glue, preferably construction mastic, may be applied instead of or, more preferably, in combination with fasteners to secure the blocks to each other.

Referring now to FIGS. 9 and 10, another embodiment of a block 156 of the present invention is depicted. The block 156 is generally angularly-shaped and includes a front face 158, a rear face 160, a top surface 164, a bottom surface 166 and pairs of side surfaces 168a, 169a, and 168b, 169b, respectively. As with the previously described blocks 112, the side surfaces 168a, 169a, and 168b, 169b are provided with grooves 170a and 170b that are configured to receive portions of lateral support beams, and will not be discussed here in detail. An alternate embodiment of the block 156′ is illustrated in FIGS. 1-2a. As shown in FIGS. 9-10, front face 158 is formed with a roughened or weathered surface or facing segments 159a-b and is provided with marginal areas 163a-d. These features are not necessary to carry out the spirit of the invention, however. The front face 158 may be dressed, modified, or otherwise worked in any desired manner. The block 156 may also be provided with recesses 167a and 167b, located on the rear face segments 161a and 161b, adjacent the side surfaces 169a and 169b. As discussed previously, the recesses 167a-b prevent and/or reduce chipping during the manufacturing process.

As depicted, the block 156 is configured so that the front face segments 159a and 159b, and the rear face segments 161a and 161b are oriented so that they intersect each other at a predetermined angle 172. The angle of intersection 172 can vary from about 15 degrees to about 165 degrees. Preferably, though, the angle of intersection is about 90 degrees so that the block may be used to construct rectilinear structures. In that regard, it will be appreciated that the blocks 156 may be used with or without linearly shaped blocks to form columnar structures of varying shapes and sizes (see, for example FIG. 1). Moreover, it is envisioned that the blocks may be formed with more than two front and rear face segments 159a-b, 161a-b, and/or that the block could be formed in a generally arcuate shape.

Referring now to FIG. 11, an embodiment of a beam of the present invention generally comprises an elongated spine or web and at least one rib, which is substantially coextensive therewith. More specifically, a preferred embodiment of beam 16, as shown, includes a plurality of ribs that are arranged in a substantially coplanar and collateral relation. That is, there is a first pair of ribs 38a, which are substantially coplanar and extend away from each other. And, there is a second pair of ribs 38b, which are also substantially coplanar and extend away from each other. Note that the pairs of ribs 38a and 38b are in substantial collateral relation with each other and are spaced apart from each other by a distance defined by the web 36. This configuration of two pairs of ribs 38a and 38b attached to each other by web 36 forms somewhat of an I-beam configuration. It is preferred that at least one set of ribs 38a be resiliently deformable and, even more preferred, that they converge slightly towards and then diverge slightly away from the other ribs 38b in a somewhat “V”-shaped configuration towards the ends of the ribs 38. A “V”-shaped configuration is preferred because it allows a segment 35 of a block 12 to be gripped between the ribs 38a-b (see, for example, FIGS. 23 and 24). As will be appreciated, in order for the desired amount of gripping force to occur, the distance or span 42 between a rib 38b and the apex of the “V” of an unflexed rib 38a should be slightly less than the thickness of segment 35 (see FIG. 24). It will also be appreciated that the distance or span 43 between the leading edge of flange 40 of the unflexed rib 38a and the rib 38b should be slightly greater than the thickness of segment 35 (See, again FIG. 24). Thus, when a beam 16 is attached to a block 12 the rib 38a is deflected from its unstressed state to a stressed state and a segment 35 of a block may be gripped between ribs 38a and 38b. As depicted in FIG. 23 the ribs 38a and 38b are preferred because they prevent unwanted movement and misalignment between blocks 12 of a given column 14 and they are able to compensate for variations in dimensions that sometimes occur during manufacture of the blocks.

Beam 16 may be attached at its upper ends to a structure being skirted (see, for example, FIG. 1) if desired, preferably at or near the lowermost edge or bottom of the structure, and using conventional fastening techniques and technologies. Such attachments may be used in conjunction with or without a bracket 18 to provide support and stability to the independent columns 14 (see FIG. 5) by preventing them from leaning or falling forwardly or rearwardly. The beams aligns the blocks 12 of a given column), by preventing lateral movement therebetween (that is, movement along the “x” direction in a three-dimensional coordinate system relative to the blocks 12).

Another embodiment of a lateral support beam 116 is depicted in FIG. 1a. Here, the beam 116 generally comprises a body having block-engaging portion and a bracket-engaging portion. More specifically, the beam 116 comprises a first web 180 and a second web 181 that are generally aligned with each other. Projecting from the webs 180, 181 are pairs of ribs 182a, 182b, and 182c. The first pair of ribs 182a, which form the block-engaging portion, extend away from each other in a generally coplanar relation. The second pair of ribs 182b is generally collaterally aligned with the first pair of ribs 182a and is separated therefrom by a predetermined span 188. The third pair of ribs 182c is generally collaterally aligned with the second pair of ribs 182b and is separated therefrom by a predetermined span 190. The outer ends of ribs 182a are provided with resilient flanges 184 that are configured and arranged such that the ribs 182a are able to be received by the vertical grooves on the blocks. With this beam embodiment, segments of the sides of a block are not gripped between adjacent pairs of ribs. Rather, engagement with blocks is achieved through the first set of ribs 182a that substantially span the depth of the vertical grooves of the blocks, where depth is taken along the “z” axis in the three dimensional coordinate system (see, for example, FIG. 7a). It will be appreciated that the block engaging portion, i.e., the first pair of ribs 182a, need not be restricted to a flange configuration. A frictional engagement, for example, can be achieved with other configurations.

Alternative embodiments of support beams 270, 287 and blocks 312 are illustrated in FIGS. 12, 13 and 27. With regard to the support beam 270 depicted in FIG. 12, support beam 270 comprises a pair of webs 272, 274, which are generally parallel to each other and that terminate in opposing ribs. A third web 276 extends from the surface formed by opposing ribs in general alignment with webs 272, 274 and terminates in opposing ribs 278c. The ends of opposing ribs 278a and 278b may be provided with flanges and coupling elements 280, 282, respectively. As will be appreciated, two webs 272, 274 (versus a single web) increases the overall strength of the beam 270 so that the beam resists bending and warping more than beams that have only single webs that connect their opposing ribs.

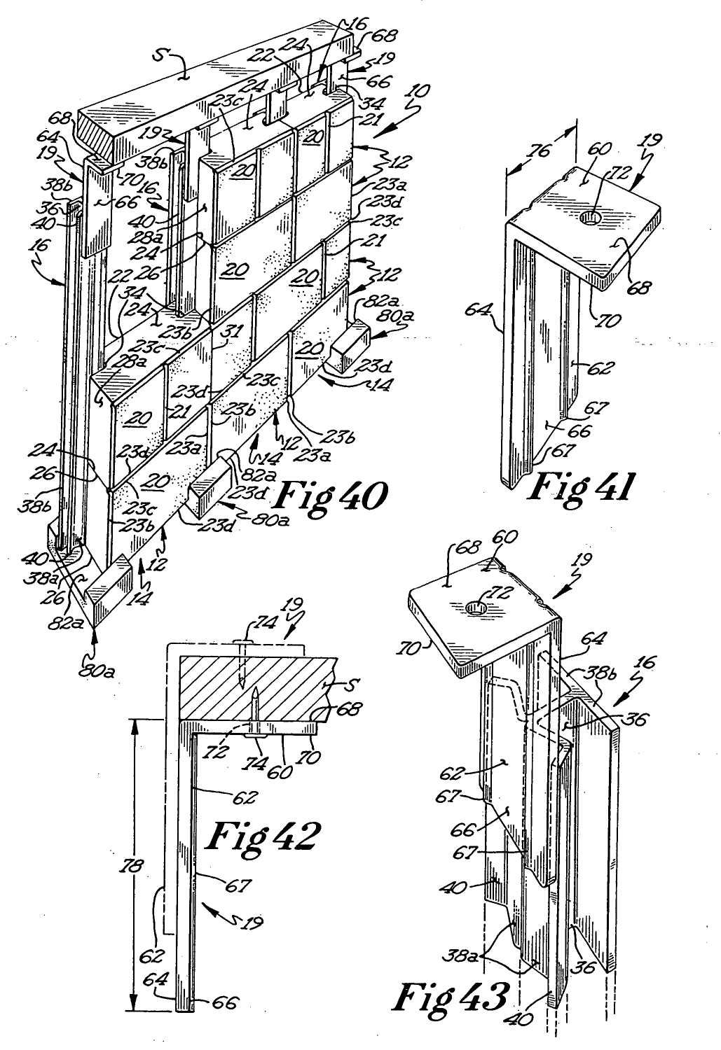

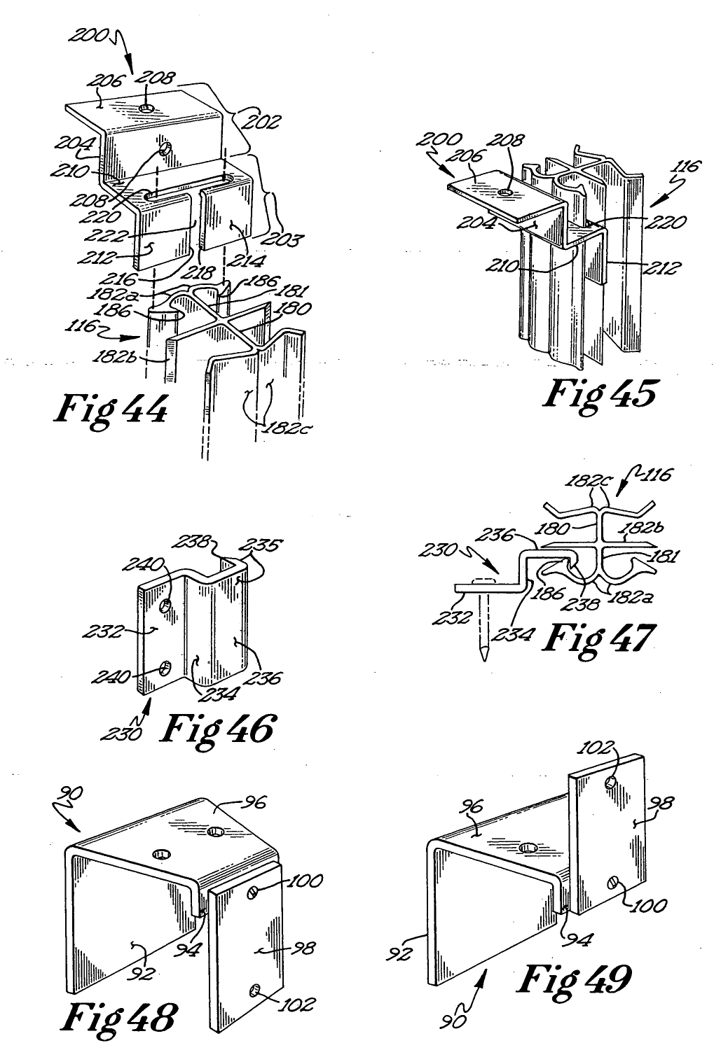

The support beam 287 of FIG. 13 is similar to the support beam 270 of FIG. 12. Instead of having opposed ribs that engage a block, however, the block engagement section 288 of the beam is configured so that it is able to substantially span the depths of the grooves of two opposing blocks, or the depth of the aperture 350 in the interior section of a block 312 (see FIG. 27) (where depth is taken along the “z” axis in the three dimensional coordinate system as shown in FIG. 7a). As depicted, the engagement section 288 of the support beam 287 is generally “T”-shaped and substantially spans the depth of the aperture 350 (i.e. see FIG. 27) where depth is taken along the “z” axis in the three dimensional coordinate system as shown in FIG. 7a (see FIG. 45, for example), and generally spans the width of the slot 352 of a block (see, FIG. 27). As shown, the engagement section 288 is hollow, however, it is understood that the engagement section 288 may be solid, if desired. The base of the “T”-shaped engagement section 288 is provided with a web 276 and a pair of opposing ribs 278c to enable the support beam 287 to be connected to a bracket such as those depicted in FIGS. 44-45. With regard to FIG. 27, it will be appreciated that the depiction of the support beams 270 and 287 relative to the blocks 312 are for illustrative purposes only, and that they may be interchanged if desired.

A frictional engagement may be desired and this could be achieved with other configurations. For example, in FIG. 14 the block-engaging section 288 may take the form of generally planar opposing planar sections 192 each having resilient spurs 194 projecting therefrom. Or, as seen in FIG. 15, the block-engaging section 288 may take the form of a preformed resilient body 196 having an aperture 198. Note that in FIGS. 14 and 15, the bracket-engaging portions 290 are shown in phantom.

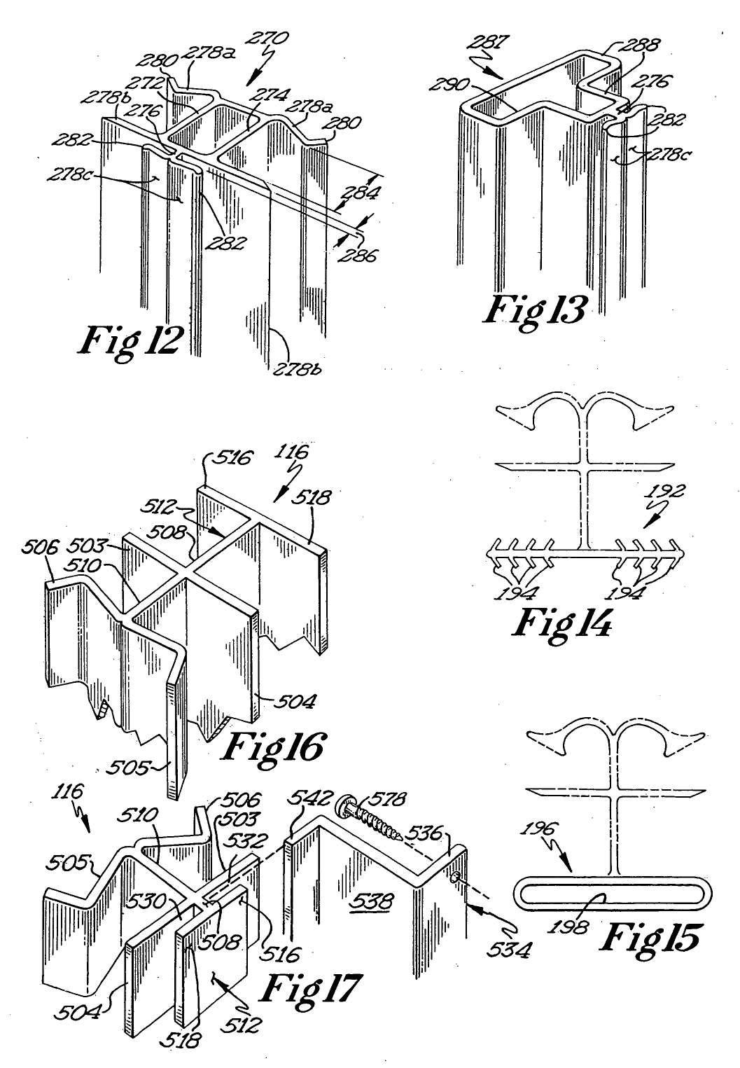

With reference to FIG. 16, the support beam 116 is similar to the support beam of prior embodiments in that it includes a web 510 from which a plurality of ribs 503, 504, 505 and 506 extend. In a departure from previous embodiments, the support beam 116 of this embodiment includes an extension 508 that terminates with an attachment member 512. Preferably, the extension 508 is aligned with, and extends from the web 510 so as to position the attachment member 512 a predetermined distance from the plurality of ribs 503, 504, 505 and 506. This arrangement serves several purposes. As explained above, not only does the extension 508 create spaces between a wall structure and a substructure that may be used as plenums, conduits, or for retaining insulative, fire-retardant or other building materials, but it also facilitates attachment of the support beam 116 to a substructure. Preferably, the attachment member 512 comprises feet 516 and 518 that extend laterally in opposite directions from the extension 508 to provide a point or points of connection which may be used with adhesive or fastening elements, such as nails or screws, in attaching a support beam to a substructure (see also, FIG. 29).

Referring now to FIG. 17, the support beam 116, again, has an extension 508, which terminates in an attachment member 512 having feet 516, 518. However, in this embodiment, the extension 508 and the feet 516, 518 are foreshortened. Note that the support beam 116 is not directly connected to a substructure but is operatively connected to a bracket 534 that is, in turn, operatively connected to a substructure. The bracket 534 includes a substructure engaging portion 536, a span 538 and an attachment member with a support beam engaging portion 542. The support beam engaging portion 542 is sized to be snuggly received and frictionally retained within a channel 530 or 532 formed by a rib and a foot 505, 516; 506, 518, respectively, of the beam 116. Note that the support beam 116 need not extend along the length of the bracket 534, and more particularly, the support beam 116 need not be coextensive with the side of a block 112 (see FIG. 7a) to which it may be operatively connected. The reason for this is that a block need not be retained along its entire length of its grooves to be adequately retained as part of a wall structure. Instead, it is only necessary for a block to retained at several points. Thus, the support beams 116 may take the form of clips that attach to the bracket 534, and a block 112 can be retained at a plurality of predetermined locations (i.e. such as upper and lower ends). It will be appreciated that such support beam clips may be used to operatively connect a pair of blocks to a support bracket by positioning the clips so that they span the interface between two adjacent blocks. It will also be appreciated that the support beam clip may be longer than a side of a block to which it is operatively connected so that it may operatively connect more than two blocks to a bracket.

The span 538 of the bracket 534 serves to position the support beam 116 a predetermined distance from a substructure while the substructure engaging portion 536 serves to attach the bracket 534 to a substructure. As with the aforementioned embodiment, the bracket 534 may be operatively connected to a substructure using a variety of fastening elements. It will be appreciated that both channels 530, 532 of the support beam 116 of this embodiment may be used with oppositely facing brackets, if desired, to form a more robust connection between the wall structure and a substructure.

Referring now to FIG. 18, the support beam 116 terminates at an attachment member 512 that includes two spaced apart resilient walls 550, 552 having confronting arms 554, 556, which define a slot 558 and channel 560, which are sized to admit and retain a second attachment member.

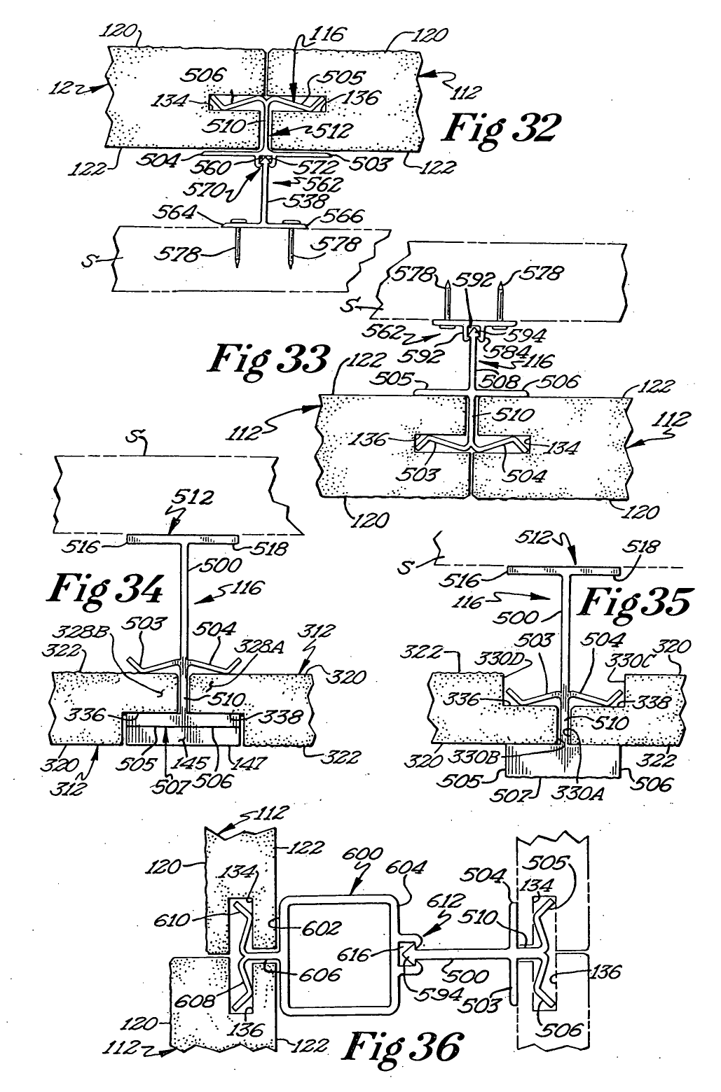

With this embodiment, the support beam 116 is not directly connected to a substructure but is operatively connected to a bracket 562 that is, in turn, operatively connected to a substructure (see, for example, FIG. 32). The bracket 562 includes substructure engaging portions 564, 566, a span 538 and a first attachment member 570. Preferably, the first attachment member 570 is a dart-shaped head 572 having shoulders 574, 576 that are configured to engage arms 554, 556 of the support beam 116 in a constrained relation. That is, the attachment member 512 of the support beam is sized to slidingly receive the head 572 within a slot 558 and a channel 560 formed by the resilient walls 550, 552 and their confronting arms 554, 556. Thus, the support beam 116 may be connected to a bracket 562 in a constrained manner. It will be appreciated that the support beam 116 can be operatively connected to the bracket 562 in several ways. For example, by positioning the bottom of the channel 560 and the slot 558 over the top of the dart shaped head 572 and the span 568 of bracket 562 and then sliding the support beam 116 down along the bracket 562 and interconnecting with an already positioned block, or sliding the support beam down along the bracket 562 and later interconnecting with a block, which is slid into position in a similar manner. Alternatively, a support beam 116 may be operatively connected to a bracket 562 by aligning the slot 558 of the attachment member 512 opposite the apex of the dart shaped head 572 and then pushing the support beam 116 towards the dart shaped head 572 until the arms 554, 556 of the attachment member 512 engage the shoulders 574, 576 of the dart shaped head 572.

As will be appreciated, the support beam 116 of FIG. 18 need not extend along the length of the bracket 562 and, more particularly, the support beam need not be co-extensive with the side of a block to which it is operatively connected. The span 538 of bracket 562 serves to position the support beam 116 a predetermined distance from a substructure and the substructure engaging portion 564, 566 serves to attach the bracket 562 onto a substructure. Bracket 562 may be operatively connected to a substructure using a variety of fastening elements 578 (see also, FIG. 32).

Referring now to FIG. 19, the operative connection is reversed from that shown in FIG. 18. That is, support beam 116 includes an extension that terminates in a first attachment member 570 having a head 594 with shoulders 596, 598. The bracket 580 now includes two spaced-apart resilient walls 582, 584 having confronting arms 586, 588, which define a slot 590 and a channel 592, which are sized to admit and retain the attachment member 594 in a constrained relation, as discussed above. As with the aforementioned embodiments, the support beam 116 need not extend along the length of the bracket 580. The bracket may be operatively connected to a substructure using a variety of fastening elements.

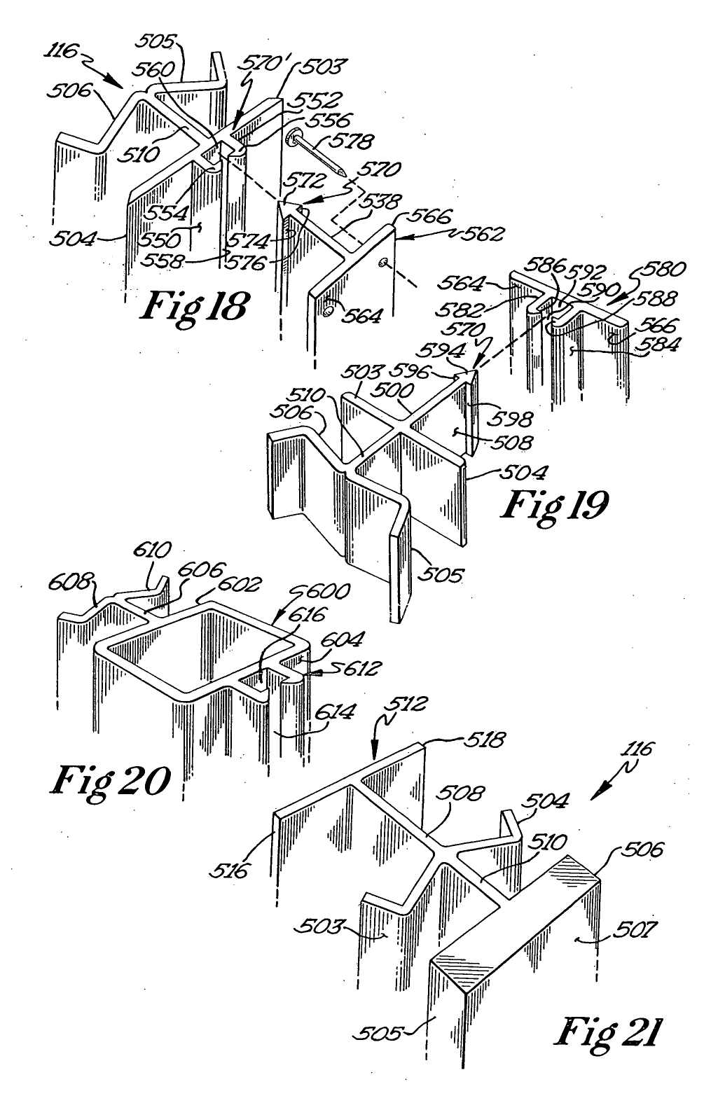

Referring now to FIG. 20, another preferred embodiment depicts a post 600 which has been provided with a plurality of connectors to enable the post 600 to support a plurality of wall structures. In this embodiment, the post 600 includes front and rear surfaces 602, 604 and opposing sides, with a web 606 that extends from the front surface 602, and an attachment bracket 612 that extends from the rear surface 604. A pair of ribs 608, 610 extend laterally in opposite directions from the web 606 in the same manner as the ribs 38 of support beam 16 in FIG. 11, while the attachment bracket 612 includes a slot 614 and channel structure 616 similar to the slot 558, 590 and channel 560, 592 structures described and shown in FIGS. 18 and 19, respectively. Thus, with this embodiment, blocks may be directly connected to the post 600 at side 602 or connected indirectly at side 604 via an appropriately configured support beam (such as beam 116 of FIG. 19).

Although not shown, other combinations of operative connections may also be used. For example, the post 600 may be provided with two direct connectors (webs with laterally extending ribs) or the post may be provided with two indirect connectors (attachment members, such as channels). As will be appreciated, the post 600 may be operatively connected to a substructure such as a footing or foundation, or be set into the ground using known techniques and technologies. While the post 600 is depicted as having a hollow cross-section, it is understood that the post may also be a solid in cross section or may have a reinforcing structure such as a pipe or a rod received therein.

With reference to FIG. 21, the support beam 116 is similar to the support beam of prior embodiments, in that it includes a web 510 from which a plurality of ribs 503, 504, 505 and 506 extend. The support beam 116 includes an extension 508 that terminates with an attachment member 512. Preferably, the extension 508 is aligned with, and extends from the web 510 so as to position the attachment member 512 a predetermined distance from the plurality of ribs 503, 504, 505 and 506. In FIG. 21, the attachment member 512 is depicted as feet 516 and 518, however it is understood that the attachment member may take other forms. Note that ribs 503, 504, 505 and 506 are reversed relative to each other so that the pair of opposing ribs 505 and 506 are now forward, relative to the opposing pair of ribs 503 and 504 (similar to the rib arrangement as depicted in FIGS. 23 and 24). Note also,. that the pair of forwardly facing opposing ribs 505 and 506 are somewhat thicker than the pair of opposing ribs 503 and 504. This feature allows the support beam 116 to have a viewable surface 507, which may form part of an observed wall structure (see FIG. 35).

Referring now to FIG. 22, a partial horizontal section of the wall structure 10 of FIG. 4 is depicted. As shown, a beam 16 operatively connects two adjacent blocks 12 of adjacent columns 14 to each other. Here, the “V”-shaped ribs 38a are positioned within grooves 34 of adjacent blocks 12 and ribs 38b are positioned against the rear faces 22 of adjacent blocks 12. In this configuration, the beam 16 remains hidden from view and provides support along several axes (taken along the “z” and “x” directions in a three-dimensional coordinate system relative to a block 12). With the beam 16 of this embodiment, the grooves 34 may be considerably larger than the thickness of the ribs 38a, without affecting the gripping ability of the beam 16. Thus, there may be quite a large space in front of the ribs 38a. Note that the distance between side surfaces 29a and 29b of block 12 is less than the distance between side surfaces 28a and 28b of block 12 to allow the side surfaces 28a, 28b of adjacent blocks 12 to be brought into intimate contact with each other while providing enough space to accommodate the web 36 of the beam 16 (see FIGS. 24 and 24a). Note that a bracket 18 is shown (in dashed lines) as it would be positioned relative to an uppermost block 12 of a column 14.

FIGS. 23 and 24 show a preferred beam arrangement in which the beam 16 shown in FIGS. 11 and 22 is reversed with respect to blocks 12 to which the beam is connected. That is, the ribs 38b are positioned within opposing grooves 34 and ribs 38a are positioned against the rear faces 22 of blocks 12. This arrangement does not significantly change the function and gripping ability of the beam 16 as discussed above.

As with to the embodiment depicted in FIG. 22, the distance between side surfaces 29a and 29b of the blocks is less than the distance between side surfaces 28a and 28b to allow side surfaces 28a, 28b of adjacent blocks 12 to be brought into intimate contact with each other while providing enough space to accommodate the web 36 of the beam 16. Note that when two adjacent blocks 12 are brought into contact with each other, their corresponding margins 23a and 23b combine to form a profile that is substantially the same as the profile of a splitting recess 21 (as shown in FIGS. 22 and 24). It will be appreciated that the splitting recess 21 and may have other profiles, such as a “V”-shape and that the corresponding margins would be more beveled or chamfered.

Referring now to FIGS. 23, 23a, 24 and 24a, operatively connecting blocks together to form a wall structure 10 begins with connecting a block 12 to a beam 16. As depicted in FIGS. 23a and 24a, the leading edge of flange 40 allows the rib 38a to be displaced as it encounters the block segment 35. As the beam 16 is connected to the block 12, block segment 35 is gripped by ribs 38a and 38b.

In a preferred method to operatively connect a wall to a structure using the aforementioned bracket, a person would prepare or otherwise select an appropriate location in which to construct a wall. The construction would begin by placing a first block having opposing side grooves in a desired position and orientation. Then, a second, similar block would be placed directly on top of the first block so that the opposing side grooves of the first and second blocks are in vertical alignment with each other and the first and second blocks form a column. Next, the first and second blocks would be operatively connected to each other along one of their respective sides by inserting a rib of first support beam into the aligned grooves and seating it securely.

Next, a bracket is positioned so that its wall engaging portion is collaterally aligned and in contact with the support beam such that it extends therewith along the groove in the block. The structure engaging portion of the bracket is then brought into position for attachment to a structure by sliding or otherwise manipulating the bracket in a direction towards the point of attachment on the structure (this is generally above and co-planar with the wall). The bracket is than attached to the structure using conventional techniques and technologies. The rib of a second support beam is then inserted into the aligned grooves of the opposite sides of the blocks, and a second bracket is used to operatively connect this portion of the wall to a structure using the aforementioned steps.

A second column comprising similarly configured third and a fourth blocks may now be constructed. The operation is much the same, except now the third block is positioned so that one of its sides is adjacent to one of the sides of the first block and its groove engages at least one other rib of one of the already positioned support beams. The fourth block is then positioned on top of the third block in a similar manner. That is, the fourth block is positioned so that one of its sides is adjacent to one of the sides of the second block and its groove engages at least one other rib of one of the already positioned support beam and the wall engaging portion of the already installed bracket.

After the second column is erected, the third and fourth blocks would be operatively connected to each other along their respective free side by inserting at least one rib of a third support beam into their aligned vertical groove of the respective sides of the first and second blocks and seating them securely, and that support beam would be operatively connected to a support by yet another bracket. And so on. It will be appreciated that other methods of constructing a wall structure using the aforementioned components are possible.

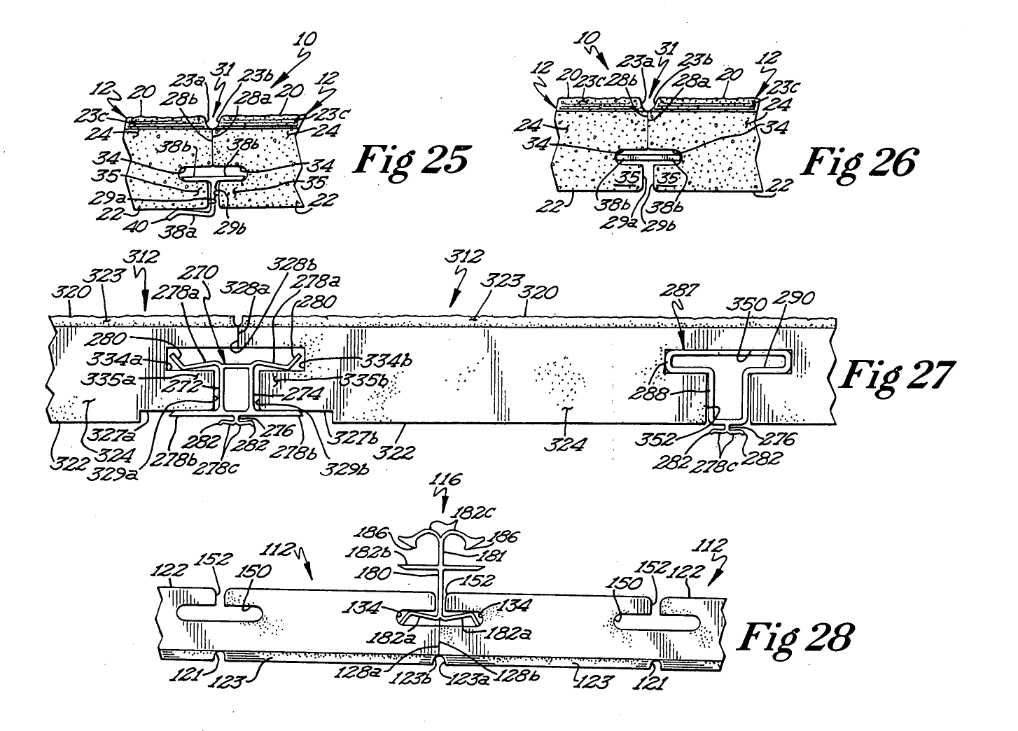

FIG. 25 illustrates an alternative embodiment of a beam 16 having two ribs 38a, 38b but only one resiliently deformable rib 38a. FIG. 26 shows yet another embodiment of a beam 16 comprising one pair of opposed ribs 38b such that the support beam 16 is essentially an elongate spline. It should be understood that for purposes of clarity, the ribs 38b as depicted in FIGS. 25 and 26 are substantially thinner than the grooves 34 in which they are positioned, and that in actuality ribs 38a-b and grooves 34 would be configured to effectively maintain blocks 12 in a coplanar relation with little or no play.

Alternative embodiments of support beams and blocks are shown in FIG. 27. As depicted in FIG. 27, a support beam 270 may be operatively connected to one or more blocks 312, at grooves 334a and 334b. Note that the blocks 312 include a front face 320, a rear face 322, a top surface 324, a bottom surface (not shown), and side surfaces 328a and 329a, and 328b and 329b. The blocks 312 also include marginal areas 323 and notches 327, which will not be discussed here in detail. As can be seen, the side surfaces 329a and 329b are foreshortened to accommodate the increased width of the support beam 270. The support beam 270 may be operatively connected to a block 312 when the ribs 278a and 278b grip side segments 335a, 335b. The support beam 287 can be operatively connected to a block 312 by sliding a block engagement section 288 into the aperture 350.

Another embodiment of a lateral support beam is depicted in FIG. 28. Here, the beam 116 generally comprises a body having block-engaging portion and a bracket-engaging portion. More specifically, the beam 116 comprises a first web 180 and a second web 181 that are generally aligned with each other. Projecting from the webs 180, 181 are pairs of ribs 182a, 182b, and 182c. The first pair of ribs 182a form block-engaging portions, which extend away from each other in a generally coplanar relation. The second pair of ribs 182b is generally collaterally aligned with the first pair of ribs 182a and is separated therefrom by a predetermined span 188. The third pair of ribs 182c is generally collaterally aligned with the second pair of ribs 182b and is separated therefrom by a predetermined span 190. The outer ends of ribs 182a are provided with resilient flanges 184 that are configured and arranged such that the ribs 182a are able to be received by the vertical grooves on the blocks of the present invention. With this embodiment, segments of the sides of a blocks re not gripped between adjacent pairs of ribs.

Now referring to FIG. 29, a support beam 116, similar to the support beam of prior embodiments, includes a web 500 from which a plurality of ribs 503, 504, 505 and 506 extend. The support beam 116 of this embodiment includes an extension 508 that terminates with an attachment member 512. Preferably, the extension 508 is aligned with, and extends from the web 500 so as to position the attachment member 512 a predetermined distance from the plurality of ribs 503, 504, 505, and 506. The extension 508 not only creates spaces between a wall structure and a substructure that may be used as plenums, conduits, or for retaining insulative, fire-retardant or other building materials, and also facilitates attachment of the support beam 116 to a substructure “S” (partially shown). Preferably, the attachment member 512 comprises feet 516, 518 that extend laterally in opposite directions from the extension 508 to provide a point or points of connection which may be used with adhesive or mechanical fastening elements, such as nails or screws 522, in attaching a support beam to a substructure “S”.

FIG. 30 illustrates a partially assembled wall structure 410 comprising a plurality of blocks 412 retained in place by a plurality of vertically oriented, elongated support beams 416 that are operatively connected to a substructure “S” (shown in dashed lines). The support beams 416 allow the blocks 412 of adjacent horizontal courses to be substantially superposed one above the other and not laterally offset from each other in a bond pattern, as one may expect of such a wall structure. Thus, the wall structure 410 is comprised of a plurality of adjacent columns 414a-d that may be operatively connected to each other in a serial fashion. Each block 412 of the wall structure 410 includes a front face 420, a rear face 422, a top surface 424, a bottom surface 426 and opposing sides 427a, 427b. Each opposing side 427a, 427b includes opposing grooves 434, 436 defined by plurality of outwardly extending fingers 428a, 428c and 428b, 428d, with outwardly facing surfaces 430a, 430c and 430b, 430d.

Preferably, the blocks 412 are symmetrically formed, so that either the front or rear face 420, 422, respectively, may face forwardly. This feature allows a block which has been damaged or had its surface otherwise altered to be easily removed and reinstalled by merely turning the block around (or over) so that other good or undamaged sides now being the viewable surface of the block. In other words, the blocks are reversible. The front and rear faces need not have the same surface treatment. That is, a block 412 may have a smooth front face and a roughened rear face 422. Or, a block 412 may have roughened front face and a decorated or non-planar rear face. For example, in FIG. 30, the lower most blocks 412 of column 414c and column 414d, respectively, have forwardly facing rear faces 422 while the remaining blocks in the partially assembled wall structure 410 have forwardly facing front faces. As depicted, the viewable front faces 420 of the blocks 412 of the wall structure 410 are smooth and the viewable rear faces 422 of the blocks of the wall structure 410 are roughened or otherwise decorated. Note that the leftmost beam 416 may be used to form the base and a cap of a horizontally oriented wall structure.

Referring now to FIG. 31, a support beam 116, has an extension 508, which terminates in an attachment member 512-with feet 516, 518. However, in this embodiment the extension 508 and the feet 516, 518 are foreshortened. Note that the support beam 116 is not directly connected to a substructure “S” but is operatively connected to a bracket 534 that is, in turn, operatively connected to a substructure “S” (shown in dashed lines). The bracket 534 includes a substructure engaging portion 536, a span 538 and an attachment member with a support beam engaging portion 542. The support beam engagement portion 542 is sized to be snuggly received and frictionally retained within a channel 530 or 532 formed by a rib and a foot (505, 516; 506, 518, respectively) of the beam 116. Note that the support beam 116 need not extend along the length of the bracket 534, and more particularly the support beam need not be coextensive with the side of a block to which it is operatively connected. The reason for this is that a block 112 need not be retained along its entire length of its grooves to be adequately retained as part of a wall structure. Instead, it is only necessary for a block to retained at several points. Thus, the support beams 116 may take the form of clips that attach to the bracket 534, and a block 112 may be retained at a plurality of predetermined locations such as its upper and lower ends. It will be appreciated that such support beam clips may be used to operatively connect a pair of blocks to a support bracket 534 by positioning the clips so that they span the interface between two adjacent blocks. It will also be appreciated that the support beam clip may be longer than a side of a block to which it is operatively connected so that it may operatively connect more than two blocks to a bracket.

The span 538 of the bracket 534 serves to position the support beam 116 a predetermined distance from a substructure “S” while the substructure engaging portion 536 serves to attach the bracket 534 onto a substructure “S”. As with the aforementioned embodiment, the bracket 534 may be operatively connected to a substructure “S” using a variety of fastening elements. It will be appreciated that the support beam 116 of this embodiment may be used with oppositely facing brackets, if desired, to form a more robust connection between the wall structure and a substructure “S”.

Referring now to FIGS. 32 and 18, the support beam 116 does not have an extension. Rather, as best shown in FIG. 18, the beam 116 terminates at a first attachment member 512 that includes two spaced apart resilient walls 550, 552 having confronting arms 554, 556, which define a slot 558 and channel 560 that are sized to admit and retain a second attachment member 570.

With this embodiment, the support beam 116 is not directly connected to a substructure “S” but is operatively connected to a bracket 562 that is, in turn, operatively connected to a substructure “S” (shown in dashed lines). The bracket 562 includes substructure engaging portions 564, 566, a span 538 and an attachment member 570. As best shown in FIG. 18, the attachment member 570 is dart-shaped head 572 having shoulders 574, 576, which are configured to engage confronting arms 554, 556 in a constrained relation. That is, the attachment member 570 of the support beam is sized to slidingly receive the dart shaped head 572 within a slot 558 and channel 560 formed by the resilient walls 550, 552 and their confronting arms 554, 556. Thus, the support beam 116 may be connected to the bracket 562 in a constrained manner. It will be appreciated that the support beam 116 may be operatively connected to a bracket 562 in several ways. For example, by positioning the bottom of the channel 560 and the slot 558 over the dart shaped head 572 of the bracket 562, the support beam 116 may be slid down along the bracket 562 to interconnect with an already positioned block 112. Alternatively, the beam 116 may be slid down along the bracket 562 and later interconnecting with a block 112, which is slid into position in a similar manner. Alternatively, a support beam 116 may be operatively connected to a bracket 562 by aligning the slot 558 of the attachment member 512 opposite the apex of the dart shaped head 572 and then pushing the support beam 116 towards the dart shaped head 572 until the confronting arms 554, 556 of the attachment member 512 engage the shoulders 574, 576 of the dart shaped head 572.

The support beam 116 need not extend along the length of the bracket 562, and, more particularly, the support beam need not be co-extensive with the side of a block to which it is operatively connected. The reasons for this have been discussed in conjunction with the description of FIG. 31, and for purposes of brevity will not be repeated. The span 538 of the bracket 562 serves to position the support beam 116. a predetermined distance from a substructure “S” and the substructure engaging portion 564, 566 serves to attach the bracket 562 to a substructure “S”.

Referring now to FIGS. 33 and 19, the operative connection is reversed from FIG. 32. That is, the support beam 116 includes an extension 508 that terminates in an attachment member 570 having a dart-shaped head 594 with shoulders 596, 598. The bracket 580 includes two spaced-apart resilient walls 582, 584 having confronting arms 586, 588, which define a slot 590 and channel 592 that are sized to admit and retain the dart-shaped attachment member 594 in a constrained relation, as discussed above. As with the aforementioned embodiments, the support beam 116 need not extend along the length of the bracket 562, and the bracket 562 may be operatively connected to a substructure “S” using a variety of fastening elements.

With reference to FIGS. 34 and 35, support beam 116 depicted is similar to the support beam of prior embodiments in that it includes a web 510 from which a plurality of ribs 503, 504, 505 and 506 extend. In a departure from this previous embodiment, the support beam 116 includes an extension 500 that terminates with an attachment member 512. Preferably, the extension 500 is aligned with, and extends from the web 510 so as to position the attachment member 512 is a predetermined distance from the plurality of ribs. Note that the ribs 503, 504, 505 and 506 are reversed relative to each other so that the pair of opposing ribs 505 and 506 are now forward relative to the opposing pair of ribs 503 and 504. In FIG. 34, the attachment member 512 is depicted as having feet 516 and 518, however it is understood that the attachment member may take other forms such as those depicted in FIGS. 18-20. Note also, that the pair of forwardly facing opposing ribs 505, 506 are somewhat thicker than the pair of opposing ribs 503, 504. This feature allows the support beam 116 to have a viewable surface 507, which may form part of an observed wall. As depicted in FIGS. 34 and 35, ribs 505 and 506 may be coplanar or collateral relative to the viewable faces 320, 322 of blocks in a wall structure.

Referring again to FIGS. 34 and 35, the blocks 312 that are used with the aforementioned beam 116 are similar to the blocks 112 depicted in the wall construction 110 of FIG. 30. That is, each block 312 has a front face 320, a rear face 322, a top surface, a bottom surface and opposing sides.

Each block 312 differs from the block 112 depicted in FIG. 30 in several respects. First, block 312 has only one pair of opposing fingers 328a′, 328b′ instead of the pair of opposing fingers depicted in FIG. 33. Thus, each block 312 does not have a groove that obscures a support beam rib. Instead of a groove, each block 312 has opposing ledges 334, 336 defined by pairs of side surfaces 330a, 330b, 330c, 330d and fingers 328a′, 328b′, respectively. Preferably, the thickness of the ledges 336, 338 will be substantially the same as the thickness of opposing ribs 505, 506 to enable the viewable surface of a wall structure to be substantially contiguous. However, it is understood that the thicknesses of the ledges 336, 338 and/or opposing ribs 505, 506 need not be substantially the same. For example, the thickness of the ribs 505, 506 may be greater than the thickness of the ledges 336, 338 of the blocks so that the viewable surface 507 of a support beam projects outwardly with respect to the viewable surface of the blocks of the wall structure (as in FIG. 35), or the thickness of the ribs 505, 506 may be less than the thickness of the ledges 336, 338 of the blocks so that the viewable surface 507 of the support beam is recessed with respect to the viewable surface.

Another difference between block 312 and block 112 is that the opposing laterally extending, aligned fingers 328a′, 328b′ are offset from the center plane of the block 312. As seen in FIGS. 34 and 35 this allows blocks to be operatively connected to a support beam in several configurations. In FIG. 34, for example, blocks 312 are operatively connected to a support beam so that front face 320 (left side) and rear face 322 (right side) are substantially flush with the viewable surface 507 of the support beam 116. As with the aforementioned blocks of FIG. 30, the front and rear faces may have the same surface or different surfaces. Here, the front face 320 on the left side of FIG. 34 is depicted as being smooth, while the rear face 322 on the left side of FIG. 34 is depicted as being roughened. The viewable surfaces on the right side of FIG. 34 are reversed. In FIG. 35, the blocks 312 have been rotated so that when they are operatively connected to the support beam 116 they are set back from the viewable surface 507. It will be appreciated that the blocks 312 need not be all coplanar or set back with respect to the viewable surface 507 of the support beam 116. Combinations of setback blocks and coplanar blocks are possible to create a myriad of wall surfaces. It is contemplated that such combinations may be arranged into identifiable forms or patterns and may also be arranged to display alphanumeric characters and the like. Note that the viewable surface 507 may be provided with a textured or otherwise decorated surface, which matches the surfaces of adjacent blocks. Alternatively, as depicted in FIG. 34, the forward facing surface of the support beam can be provided with a cap or strip 145 of material with a viewable surface 147, which may be textured or otherwise decorated as desired and which may be affixed or attached to the viewable surface 147 in a conventional manner.

Referring now to FIG. 36, another preferred embodiment depicts a post 600, which has been provided with a plurality of connectors to enable the post to support a plurality of wall structures. In this embodiment, the post 600 includes opposing sides 602, 604 from which extend a web 606 and a bracket 612, respectively. A pair of ribs 608, 610 extend laterally in opposite directions from the web 606, while the bracket 612 includes the slot 614 and channel structure 616 similar to the slot and channel structures described and shown in FIG. 18, respectively. Thus, with this embodiment, blocks may be directly connected to the post 600 at side 602 or connected indirectly at side 604 via an appropriately configured support beam.

Other combinations of operative connections may also be used. For example, the post 600. may be provided with two direct connectors (webs with laterally extending ribs) or the post may be provided with two indirect connectors (attachment members, such as channels). As will be appreciated, the post 600 may be operatively connected to a substructure such as a footing or foundation, or be set into the ground using known techniques and technologies. While the post 600 is depicted as having a hollow cross-section, it is understood that the post may also be a solid in cross-section or may have a reinforcing structure such as a pipe or a rod received therein (see, for example, FIG. 39).

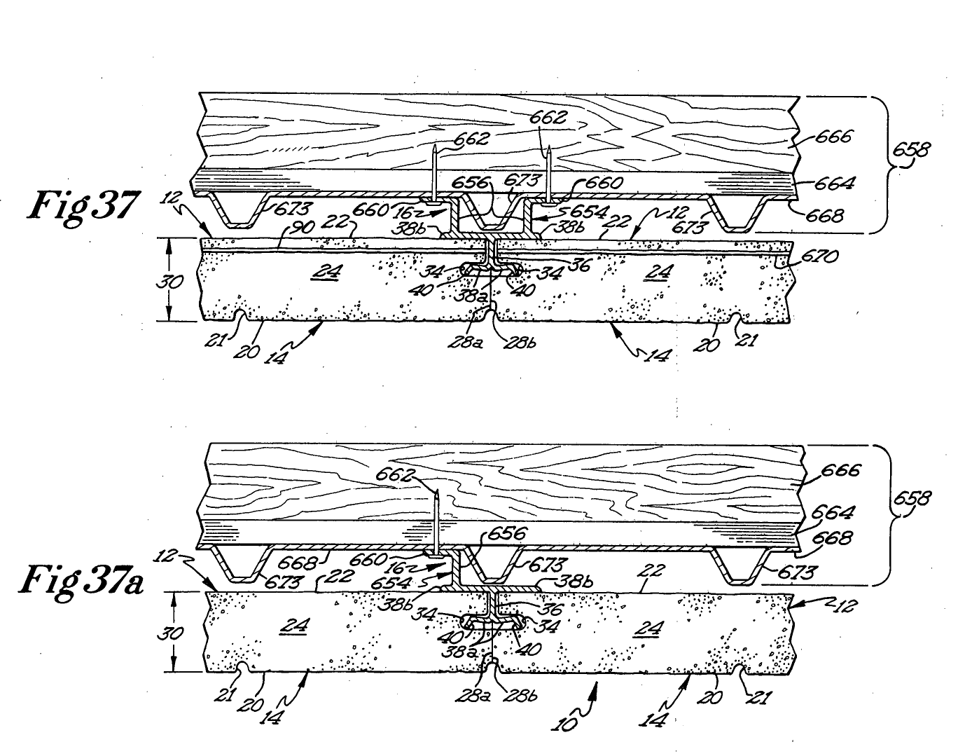

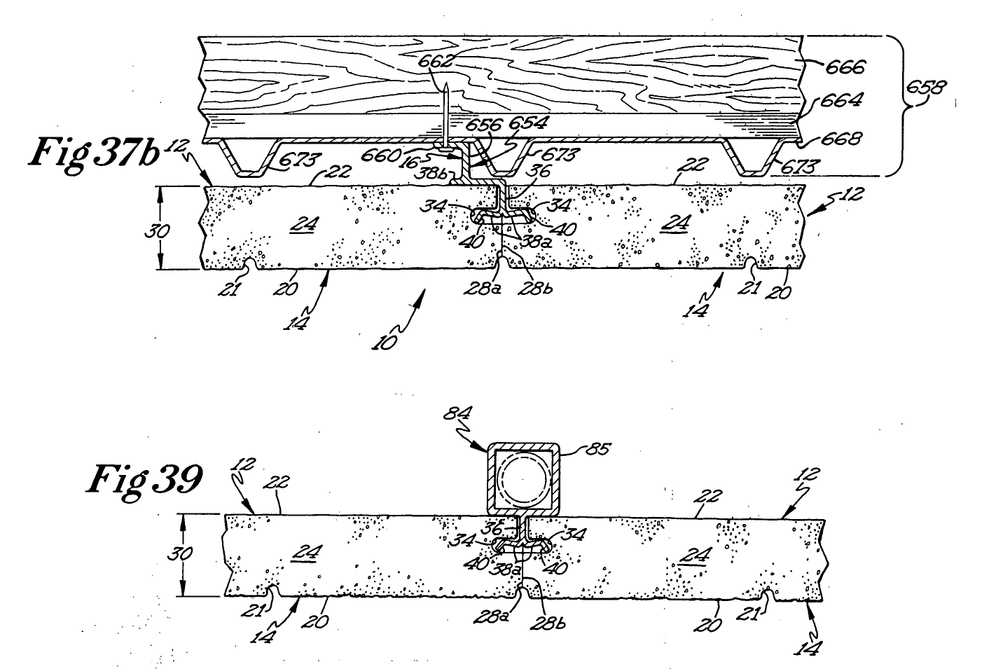

FIGS. 37-37b illustrate additional embodiments of the present invention. FIG. 37 shows a support beam 16 having a pair of leg structures 654 that are constructed and arranged to secure a wall comprising columns 14 of blocks 12 to an existing support structure 658. The support structure 658 may be a building or any other type of structure that may support a wall structure 10 according to the present invention. Legs or leg portions 656 of the leg structures 654 extend rearwardly from the support beam 16 and are preferably secured to ribs 38b thereof. The leg structures 654 may also be formed as part of the web 36 of the support beam 16. The leg portions 656 have a foot 660, which extends laterally therefrom to provide a point of connection for the support beam 16 to the existing support structure 658. Nails, screws, or other appropriate fasteners 662 may be driven through the feet 660 of the support beam 16 and into the sheathing 664 of the typical wall of the wall of the existing structure 658. The sheathing 664 is typically supported by a plurality of horizontal girts 666. Once the support beam 16 has been secured to the existing structure 658, blocks 12 are stacked between respective support beams 16 as illustrated in FIG. 37 such that ribs 38a of the support beam 16 reside in grooves 34 in the sides of the blocks 12.

In order to prevent the inflow of water into the wall structure 10, it may be desirable to apply a bead of a waterproof material 670, such as mastic or caulk, along the horizontal surfaces of the blocks 12. The bead of waterproof material 670 forms a seal between the upper surface 24 of the lower block 12 upon which the waterproof material 670 has been applied and the lower surface 26 of the block 12 immediately above the lower block 12. It will be appreciated that mastic or caulk may also be applied to the vertical side surfaces of the blocks (not shown).

Legs or leg portions 656 of support beam 16 preferably extend rearwardly from the ribs 38b in a perpendicular relationship thereto. Similarly, it is preferred that the feet 660 of the support beam 16 extend laterally perpendicular to the leg portions 656. The perpendicular relationship of the feet and legs to the remainder of the support beam 16 is the preferred embodiment thereof since the purpose of the leg portions 656 and the feet 660 to provide an offset for the wall structure from the existing structure 658. This offset allows a wall structure 10 to be secured over uneven surfaces such as corrugated steel siding 668, as illustrated in FIG. 37. As can be seen, legs or leg portions 656 of support beam 16 are sufficiently long such that the support beam 16 clears ridge 673 of the steel siding 668. As can be appreciated, steel siding 668 typically presents a plurality of vertically flat attachment surfaces. Where a wall structure 10 is to be applied to a wall of an existing structure 658 that is not vertically smooth, furring strips or blocking may be fastened to the wall of exterior of the existing structure 658 as needed. As support beams 16 provide no vertical support for the blocks 12, the blocks must be provided with some sort of foundation. Examples of suitable foundation include, but are not limited to, a concrete pad or footing that is sunk into the ground, and a cantilever ledge or bracket which is securely affixed to the wall of the existing structure.

FIG. 37a illustrates a support beam 16 having two pairs of ribs 38a and 38b separated by a web 36 and only a single leg structure 654 comprising a leg portion 656 and a foot 660. The embodiment of FIG. 37a is particularly useful when an obstruction, such as ridge 673 of steel siding 668 would prevent one of the leg structures 654 illustrated in FIG. 37 from securely contacting the wall of the structure 658. Fasteners 662 are sufficient to provide the requisite lateral support for the wall structure 10. The support beam 16 having only a single leg structure 654 may be rotated end-for-end depending on the offset location of an obstruction such as ridge 673.

Preferably, the support beams of the present invention will be extruded or molded from a material such as a plastic, a fiber reinforced resin, or a metal such as aluminum. In addition to forming embodiments of support beams 16 having the respective profiles of the support beams illustrated in FIG. 37a, it is possible that one leg structure 654 could be removed from a support beam 16 such as the support beam 16 of FIG. 37 having two leg structures 654, thereby resulting in the support beam 16 embodiment illustrated in FIG. 37a. However, where a single leg structure 654 would be sufficient to provide the needed lateral support for a wall structure 10, it would be more economical to manufacture support 16 having only a single leg structure 654. As used herein, the term “forward” means away from the center of the elevated structure (and along the “z” direction in a three-dimensional coordinate system relative to a block) and the term “rearward” means toward the center of the elevated structure (also along the “z” direction in a three-dimensional coordinate system relative to a block).

FIG. 37b illustrates a support beam 16 that is constructed and arranged to provide lateral support to a wall structure 10 as described in conjunction with FIGS. 37 and 37a. The main difference here being that the support beam 16 of FIG. 37b has a pair of ribs 38a and only a single rib 38b extending from the web 36. A leg structure 654 extends rearwardly from the rib 38b preferably in a perpendicular relation thereto. While it is preferred that the leg or leg portion 656 and foot 660 be arranged at right angles to each other and to the ribs 38b of the support beam 16, these structures may be arranged at any angle to one another provided, of course, that there is a sufficient offset from the wall of the existing structure 658 to allow installation of the blocks 12 of the wall structure 10 and that the foot 660 of leg structure 654 may be securely fastened to an supporting structure 658.

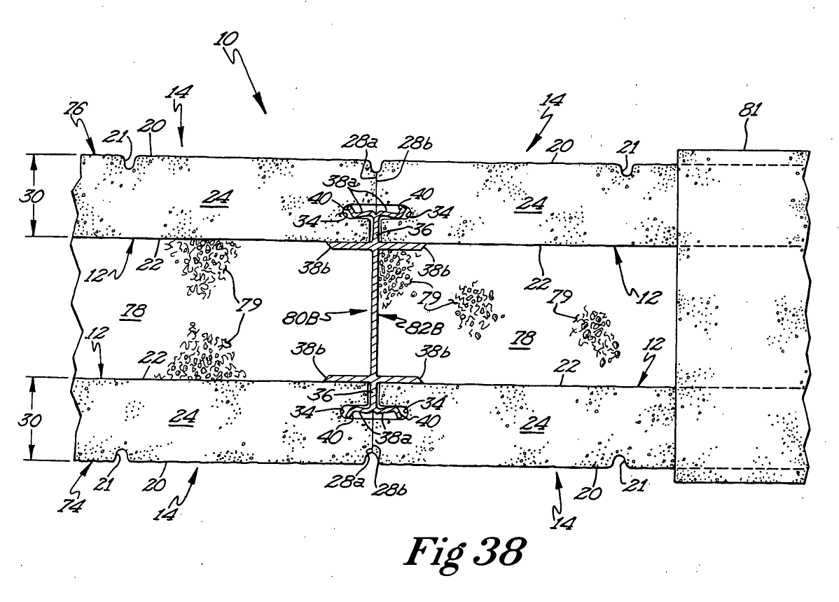

FIG. 38 illustrates a double-ended support beam 80b, which is useful for constructing a dual wall structure 10 having a front face 74 and a rear face 76. The space between the front and rear faces 74, 76 of the wall structure 10 may remain hollow or may be filled. Each end of the double-ended support beam 80b comprises a support beam or block engagement structure having a cross-sectional profile similar to the support beam illustrated in FIG. 11 arranged back-to-back in a spaced apart relation and connected by a spacer web 82b. Spacer web 82b is connected to the base pair of ribs 38b of each of the support beam portions in a perpendicular fashion. In this manner, support beam 80b couples dual walls of the wall structure 10 to provide mutual lateral support. Further support can be had by backfilling the space between the front and rear sides of the dual wall structure 10 with gravel, earth, sand, concrete or insulative material 79. Preferably, it will be appreciated that a cap 81, such may be placed over the top of the dual wall structure 10 to prevent the ingress of water, debris, or nuisance animals. It will also be appreciated that such a cap 81 may be secured to the dual wall structure by known technologies and techniques, if desired. See, for example, the use of adhesive material depicted in FIG. 37.

FIG. 39 illustrates a single-sided wall structure 10 comprising columns 14 of blocks 12 supported by a post-like support beam 84. Support beam 84 comprises a post 85 having extending therefrom a web 36. A pair of ribs 38a extend laterally from the web 36 in the same manner as the ribs 38a of support beams 16 described in conjunction with FIG. 11. As installed, post 85 is preferably rigidly seated in a footing or foundation set into the ground below the wall structure 10. As can be appreciated, blocks 12 are stacked between respective post support beams 84 as described above. The post 85 preferably has a hollow cross-section. However, post 85 may also be solid in cross-section or be provided with a reinforcing structure such as a pipe or a rod received therein. An alternate embodiment for the post or support beam 84 involves securely seating a plurality of rods or members in footings or a foundation beneath the wall structure 10 and sliding the post or beam 84 of the type illustrated in FIG. 39 thereover. Blocks 12 would then disposed between respective pairs of post support beams 84 as described above.

Now turning to FIG. 40, a wall structure 10 is depicted as it may be used in conjunction with an elevated structure “S.” As with the wall structure generally depicted in FIGS. 4 and 22, this wall structure 10 is comprised of a plurality of blocks 12 arranged in columns 14, having the columns 14 held in place by vertically oriented, lateral support beams 16, and with each beam 16 operably connecting adjacent columns 14 together. The brackets 19 used in this embodiment, however, differ from the “U”-shaped brackets 18 of the previously described embodiment in several respects. First, the brackets 19 are shaped differently than the bracket 18 of FIGS. 4 and 22. Instead of having an inverted “U”-shaped configuration as with bracket 18, the bracket 19 of this embodiment has a single, downwardly extending portion. Another difference is that rather than positioning a portion of a block 12 within an opening 50 defined by a pair of walls 44, 46, the bracket 19 of the embodiment has a wall engaging portion 62 that extends downwardly into vertical grooves 34 at the sides of blocks 12. Another difference between brackets 18 and 19 is that bracket 18 connects to a column 14 in a generally central location, whereas the brackets 19 of this embodiment connect at the sides of column 14. As with the previously described brackets 18, brackets 19 help to stabilize and prevent the wall structure 10 from tipping rearwardly or forwardly. The brackets 19 also prevent the structure from shifting from side to side.

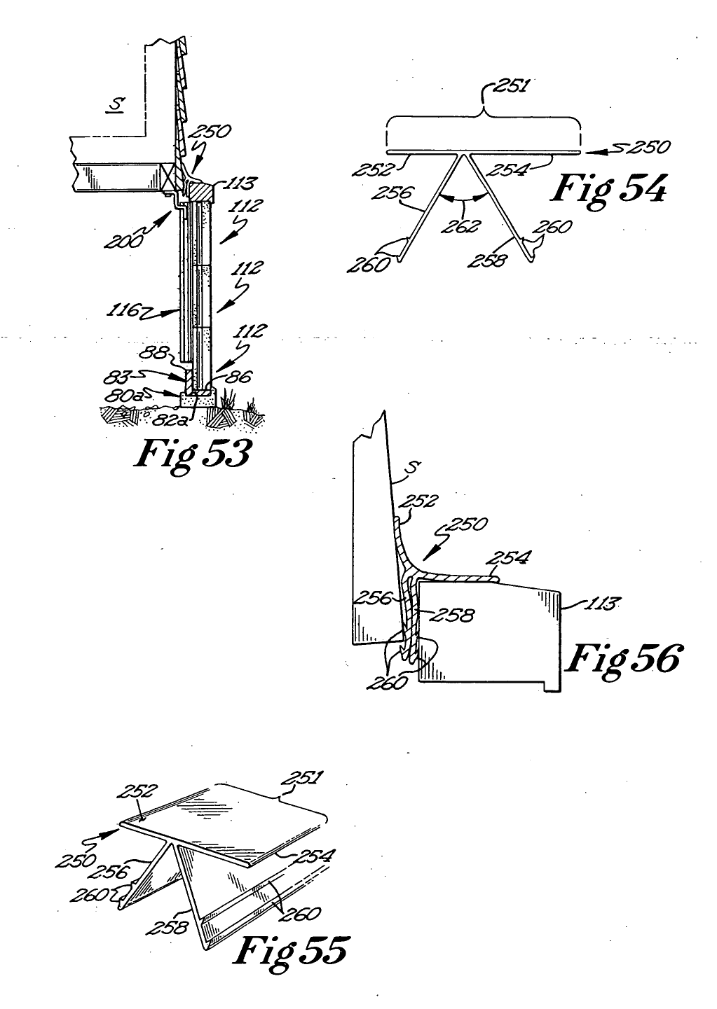

For purposes of illustration, the size of the wall structure 10 of this embodiment has been limited three columns 14 and four courses, with the two uppermost blocks of the left column 14 removed to reveal the juxtaposition between the brackets 19, beams 16 and blocks 12. Note that the wall structure 10 depicted in this embodiment also includes a plurality of footings or support pads 80a that are positioned beneath the columns 14 at the junction where they connect to the beams 16. Preferably, each footing or support pad 80a may be provided with a setting channel 82a that is configured and arranged to receive the bottom edges of one or more columns of blocks in a constrained relation. Note that the footing or support pad 80a for the middle and right columns 14 has been removed and replaced with an “L”-shaped support base or angle iron (see, for example, the support base in FIGS. 3 and 53) that spans the bottom of the middle and right columns 14. This construction can be used when the use of individual, regularly spaced footings 80a is not possible or desirable. Also note that the wall structure 10 is depicted as having a running bond on its three lowermost courses. As can be seen, the bottom and third courses of blocks do not have splitting recesses. They do, however, have their perimeter marginal areas 23a-d worked. The second course of blocks, on the other hand, have splitting recesses 21 and have only their horizontal marginal areas worked. Thus, each column 14 will have blocks with alternating front faces. When the columns of blocks are positioned adjacent each other in the normal assembly procedure some of the blocks 12 will form tight joints 31 and some of the blocks will form joints that appear substantially thicker. Thus, from a distance, the wall structure 10 will give the impression that it was constructed of blocks and mortar in a conventional manner. It will be appreciated that the externally viewable surface of the wall structure depicted in FIG. 40 is merely one example of an externally viewable surface, and that many other externally viewable surfaces are possible.

Turning now to FIGS. 41-43, a preferred embodiment of bracket 19 depicted in FIG. 40 will now be discussed. As can be seen in FIGS. 41 and 42, the bracket 19 comprises a structure engaging portion 60 and a wall engaging portion 62. The wall engaging portion 62 of the bracket 19 includes opposing surfaces 64, 66, which are arranged and configured to contact a portion of a beam 16 and a portion of a block, respectively. If desired, the wall engaging portion 62 may be provided with strengthening creases 67. As will be appreciated, the wall engaging portion 62 of the bracket 19 has a width 77 and a length 78 whose dimensions correspond to the particular blocks that are being used to construct a wall, and will be discussed only in general terms. Thus, the width 77 may range from a distance roughly equivalent to the depth of a single groove 34 in one block, to a distance roughly equivalent to the depth of two grooves 34 of opposing blocks. The width may also be roughly equivalent to the width of the web 36 of the beam 16 so that the wall engaging portion of the bracket may be oriented transversely to the wall structure. The length 78 may also vary depending upon the requirements of the wall structure (not shown). A typical width and length for a wall engaging portion 62 may be on the order of about two inches by about four inches, and a typical width and length for a structure engaging portion 60 may be on the order of about two inches by about one-and-a-half inches. It will be appreciated that the bracket 19 may be formed from material that may be modified or otherwise altered to fit a particular application. Thus, for example, the width and/or length of the wall engaging portion may be cut-to-length length or otherwise tailored at a jobsite without appreciably delaying or hindering construction.

The structure engaging portion 60 of the bracket 19 also includes opposing surfaces 68, 70. However, in this embodiment, only opposing surface 68 is configured to contact a portion of a structure (See, FIGS. 40 and 42). As depicted, the structure engaging portion 60 is attached to a lower surface of a structure “S” by an upwardly extending fastener or fastening element 73. It is understood, however, that the attachment surface of the structure can be an upper surface, in which case the opposing surface 70 would contact the surface of the structure “S” and the fastener would extend downwardly from surface 68 (shown in dashed lines). As shown in FIG. 42, the structure engaging portion 60 and the wall engaging portion 62 are planar and substantially orthogonal with respect to each other. It is understood, however, that the wall engaging portion 62 and the structure engaging portion 60 need not be orthogonal to each other. They may be linearly aligned, for example. It is also envisioned that the wall and structure engaging portions may be formed in other configurations. For instance, either portion 60, 62 may be formed with U-shaped profiles that enable the portions 60, 62 to straddle sections of the structure and/or wall. That is the structure engaging portion may be formed so that it may straddle the bottom and side edges of a structure and the wall engaging portion may be formed to engage a wall structure at its front and/or rear surfaces. The structure engaging portion 60 is provided with an aperture 72 that may be used with a conventional fastener 73. For purposes of this application, the term “fastening element” or “fastener” may include mechanical fasteners such as screws, nails, bolts, rivets, or their equivalents, and/or adhesives, weldments, or the like. Alternatively, the structure engaging portion 60 may be provided with an integral fastening element so that the portion 60 may be driven into or otherwise attached to a support.

Another embodiment of a bracket is depicted in FIGS. 44 and 45. As can be seen, the bracket 200 generally comprises a structure engaging portion 202 and a support beam engaging portion 203. More specifically, the structure engaging portion 202 comprises a first member 204 and a second member 206, which are angled with respect to each other to form a generally “L”-shaped form. The first and second members may be provided with apertures 208 that permit attachment to a structure with fastening elements such as nail and threaded fasteners. It will be appreciated, though, that attachment may also be achieved with suitable adhesives used in lieu of or in addition to fastening elements. The support beam engaging portion 203 comprises a web 210 and a pair of legs 212, 214, which are angled with respect to the web 210 to form a generally “L”-shaped form. The web 210 includes an aperture 220 that is accessible through a slot 222 defined by edges 216 and 218 of legs 212 and 214, respectively. The aperture 220 and slot 222 are configured to slidingly receive a pair of ribs and a portion of a web of a support beam. As depicted in FIGS. 44, and 45, when a support beam is attached to the bracket, the support beam is able to move in a constrained manner relative thereto. This feature allows, the bracket to be attached at different points along a structure as well as different points along a beam. Moreover, it allows a wall construction to be self-adjusting. An application of bracket 200, a support beam 116, and a plurality of brackets 112 as can be seen in FIG. 53.

Another embodiment of a bracket is depicted in FIGS. 46 and 47. The bracket 230 of this embodiment comprises a structure engaging portion 232, a connecting web 234, and a support beam engaging portion 235 that comprises a rib 236 and a coupling element 238. The bracket 230 is configured and arranged to operatively connect a support beam (such as the support beams depicted in FIGS. 11a, 28, 44, and 45) to a support. As with the previously described bracket embodiment (200), the structure engaging portion 232 may be provided with apertures 240 that permit the bracket to be attached to a structure with conventional fastening elements. Alternatively, the bracket may be attached to a support using other known technologies and techniques. When the bracket 230 is used to operatively connect a beam to a support, the coupling element 238 of the beam engaging portion 235 is slidingly retained between one of the coupling elements 186 and one of the pairs of ribs 182a. Thus configured, a support beam is able to move in a constrained or sliding manner relative thereto. This feature allows the bracket to be attached at different points along a structure as well as along different points along a beam. The bracket also permits a wall structure to be self-adjusting.

Referring now to FIGS. 48 and 49, an alternative embodiment of an attachment bracket 90 is depicted. Here, the bracket 90 is similar to earlier discussed bracket 18 (see FIGS. 4 and 22) in that it has opposing walls 92, 94 that are connected to each other by a top wall or span 96, and which retain a portion of a block in a constrained relation. However, in this embodiment, the shorter of the two walls 94 is provided with an arm 98 that is movably attached thereto by a connector 100, such as a rivet. As depicted in FIG. 48, the arm 98 is in a first position where it extends towards a block (not shown). In this position, the bracket 90 resembles bracket 18 (see FIG. 4) and may be attached at or near the underside of a structure in the usual manner, via the span 96.

In situations where it is not possible to easily attach the bracket 90 to the underside of a structure, a user of the bracket 90 need only rotate the arm 98 to a second position so that it extends away from a block (not shown) as depicted in FIG. 49. In this position, the bracket may be attached to a vertical surface via the arm by a conventional fastener, such as a nail or screw, which extends through an aperture 102. Alternatively, the bracket may be secured to a vertical surface by a suitable adhesive. As will be appreciated, the bracket 90 may be oriented so that either one of the walls 92, 94 may be in confronting relation with the front or rear face of a block.

FIGS. 50-52 illustrate brackets and beams as shown in FIGS. 2 and 2a as they may be used in conjunction with blocks to form alternative structures. Starting with FIG. 50, bracket 354 is depicted. The bracket 354 is similar to previously described bracket 200 shown in FIGS. 44 and 45 in that it generally comprises a structure engaging portion and a support beam engaging portion. However, there are differences. Instead of having a structure engaging portion that comprises a first member and a second member, structure engaging portion 356 of bracket 354 comprises a single or first member 357. As depicted, the first member 357 is provided with an aperture 360 that facilitates attachment to a structure with fastening elements such as nails, threaded fasteners, or rivets. It will be appreciated, however, that an aperture or apertures need not be present in order to attach the bracket to a structure. The fastening element(s) may be driven through the first member, if desired. Additionally, it will also be appreciated that attachment may also be achieved with suitable adhesives, in lieu of, or in addition to, fastening elements. Continuing on, the support beam engaging portion 358 comprises a web 362 and a pair of legs 364, 366, which are angled with respect to the web to form a generally “L”-shaped form. The web 362 includes an aperture 368 that is accessible through a slot 370 defined by edges 372 and 374 of legs 366 and 364, respectively. The aperture 368 and slot 370 are configured to slidingly receive a leg portion 732b and foot 734 of a support beam 716 of FIGS. 51 and 52.

Generally, the bracket of FIG. 50 may be used with beams and blocks as shown in FIGS. 51 and 52 to form wall structures similar to wall structures previously discussed. More specifically, support beam 716, as shown, comprises an elongated spine or web 718 and plurality of ribs 720 and 722, 724 and 726, which are arranged in a substantially coplanar and collateral relation so that the first pair of ribs 720, 722, which are substantially coplanar, extend away from each other in a manner similar to other embodiments already described. As shown, a first pair of ribs 720, 722 are designed to engage the grooves 728 of one or more blocks of a structure. As shown in FIG. 51, the support beams 716 may be oriented in a generally vertical direction, or as in FIG. 52, a generally horizontal direction. Note that in either orientation, the blocks would essentially be self-supporting.

In addition, the web also includes a second pair of ribs 724, 726 which are also substantially coplanar and which extend away from each other. Note that the pairs of ribs 720, 722 and 724, 726 are in substantially collateral or parallel relation with respect to each other and are spaced apart from each other by a distance defined by the web 718. The support beam 716 also includes a pair of pair of leg structures 730 having leg portions 732a-b that are similar to the leg structures of FIG. 37 in that they extend rearwardly away from ribs 724, 726 and which form a generally U-shaped channel therewith. The support beam differs, however, in that only one of the leg portions 732b includes a foot 734. As depicted, the foot 734 extends laterally away from the leg portion 732b and is generally parallel with ribs 720, 722. As with the embodiment of FIGS. 2 and 2a, the foot may be connected directly or indirectly to a support structure. However, as depicted, the beams of FIGS. 51 and 52 are operatively connected to a structure by a plurality of brackets 354, which are attached to suitable structural members. With such an arrangement the beams, which are slidingly constrained by the brackets, permit blocks to move without destroying the integrity of the structure.

As shown in FIG. 53, a bracket 200 is used as part of a wall system to operatively connect a support beam 116 to a structure “S”. Note that the lowermost course of blocks is supported by a horizontally oriented, elongated base, preferably in the form of an angle iron 83, which can be used with one or more support pads or footings 80a, if desired. The angle iron 83 includes an upper surface 86, that is configured to receive one or more blocks thereon and a sidewall 88 that prevents the block(s) from being shifted backwards. Optionally, the upper surface and/or the sidewall of the angle iron 83 may be provided with adhesive material to enable the block(s) to be secured thereto, which increases the strength and stability of the wall structure. Often, a completed wall structure will terminate in an upper course of blocks that is offset from the structure “S”. In these situations, one or more capstones or sills 113 may be used to provide a finished look, with the sills being positioned upon the upper course of blocks. As will be understood, the sills may be attached to the upper course of blocks using known technologies and techniques, such as adhesives. Sometimes, there is a gap between a capstone or sill 113 and the structure “S”, through which moisture, debris, insects, etc. may pass. This gap can be effectively closed using a sealing element 250 as depicted in FIGS. 54 and 55.

The sealing element 250 of the present invention generally comprises a body having a plurality of flexible, resilient strips that provide an effective seal between the sills or finish moldings and the structure. More specifically the sealing element 250 comprises a sealing panel 251 that is formed by first and second strips 252 and 254 and an attachment portion 255 that is formed by third and fourth strips 256 and 258. The attachment portion 255 is operatively connected to the panel 251 such that the third and fourth strips extend therefrom in a generally radial relation. As can be seen in FIGS. 54 and 55, the sealing element is in an unflexed state and the third and fourth strips 256 and 258 define an angle 262, which can range from about 15 degrees to about 165 degrees. The preferred range of the angle however is in the range of about 45 degrees to about 75 degrees. The third and fourth strips 256 and 258 may include beads or wales 260 that enable the sealing element to anchor itself into position. In use, the third and fourth strips 256 and 258 of the attachment portion 255 are pinched together and inserted into the gap between the wall and a structure, as shown in FIGS. 53 and 56. As the attachment portion 255 is seated, the first and second strips 252, 254 of the panel 251 contact the surfaces of the sill 113 and the structure “S” and exert normal forces there against. Thus, effectively seals the gap. As will be appreciated, the sealing element is maintained in position by the beads 260 that, due to the resilient nature of the strips, tend to catch against irregularities in the surfaces of the sill and the structure “S” and resist movement. As will be appreciated, the sealing element 250 may be oriented so that the first and third strips 252, 256 contact the sill 113 and the second and fourth strips 254, 258 contact the structure “S”, if desired.

There may be times when it is not possible, practical, or desirable to use beams or the combination of beams and brackets, as previously described to operatively connect blocks to a structure. In such cases, blocks may be attached to a structure using only brackets. Generally, as shown in FIGS. 57-59, each bracket comprises a structure engagement portion and a block engagement portion that are spaced from each other by a web. In one preferred embodiment, shown in FIG. 57, the bracket 754 comprises a structure engagement portion 756 that is similar to previously described structure engagement portions in that it is configured and arranged to act as a point of attachment to a structure, and comprises a member 766 having an aperture 768, with the aperture configured to be used in conjunction with a fastening element such as a nail, screw or rivet. The bracket also comprises a web 762 and a panel 760, which collectively serve to connect the structure engagement portion 756 to a block engagement portion 758, and which serve to position a block a predetermined distance from a structure to which it may be attached. While the structure engagement portion 756 and the web 762 form a generally 90 degree angle therebetween, it will be understood that the angle may be modified depending upon the configuration of the structure to which it is attached. Thus, for example, the angle could be acute or obtuse. The block engagement portion 758, which is connected to the web, comprises a plurality of generally planar sections 759a, 759b, 759c, 759d, and which are configured to cooperatively engage portions of one or more blocks such that forward and rearward movement of the blocks relative to the structure, is limited. This is achieved by forming some sections so that they are substantially coplanar with each other and forming some sections so that they are substantially parallel to each other (when viewing the bracket on edge). Note that those sections that are coplanar with each other extend away from the web in opposite directions, while those sections that are parallel to each other and spaced from each other by a panel, need not be so restricted. Note also, that the sections are configured and arranged so that when viewed from front, the sections do not overlap or superimpose upon each other. As will be appreciated, this permits to bracket to be manufactured from material such as metal and formed into the desired configuration with a series of cuts and bends. It will be understood, however, that the bracket may be manufactured from different materials (eg. plastics) and formed using different techniques (eg. molding) without departing from the spirit and scope of the invention. In use, as shown in FIG. 60 (right side), the bracket 754 operatively connects two blocks to a structure “S”.

Alternative embodiments of bracket 754 are depicted in FIGS. 58 and 59. As with the previously described bracket, these brackets 754′ and 754″, respectively, comprise a structure engagement portion, a web, and a block engagement portion. The structure engagement portions are similar to the structure engagement portion of FIG. 57 in that they are configured and arranged to act as a point of attachment to a structure, and comprises a member 766′, 766″ having an aperture 768′, 768″ respectively, with the aperture configured to be used in conjunction with a fastening element such as a nail, screw or rivet. Likewise, the brackets also comprise a web 762′, 762″ which serve to connect the structure engagement portion 756′, 756″ to a block engagement portion 758′, 758″, respectively, and which serve to position a block a predetermined distance from a structure to which it may be attached. In a departure from the web structure of FIG. 57, the webs of FIGS. 58 and 59 include an additional aperture 764′, 764″ that is configured and arranged to act as a point of attachment to a structure (see, for example, the left side of FIG. 60). As with the previously describe embodiment of FIG. 57, the angle formed by the structure engagement portion and the web (shown generally as 90 degrees) may be modified depending upon the configuration of the structure to which it is attached. The block engagement portions 758′, 758″, which are connected to respective webs, each comprise a plurality of sections 759a′and 759b′, 759a″ and 759b″, which are configured to cooperatively engage portions of one or more blocks such that forward and rearward movement of the blocks relative to the structure, is limited. This is achieved by forming the sections so that they are generally coplanar to each other (when viewing the bracket on edge) and able to engage opposing surfaces in one or more blocks. A feature common to each of the sections 758a′and 758b′, 758a″ and 758b″ is that they have a thickness 776′, 776″ that effectively spans the distance between the opposing surfaces into which they are positioned, such that forward and rearward movement of the blocks relative to the structure, is limited. In particular, the effective thickness of each section 776′, 776″ of bracket 754′, 754″ is achieved by forming creases 772 in each section to form darts 770, whose ends define the extent of the effective thickness 776′. A strengthening rib 774 may be provided for each section, if desired. The effective thickness 776′ of the sections 770 of bracket 754′ is achieved by forming the sections so that they have high and low block contacting areas, preferably by curving the sections and more preferably by forming the sections into the shape of arcs. FIG. 60 is a plan view of the brackets of FIGS. 57 and 59 operatively connecting blocks of the present invention to a substructure.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A retaining wall facia system, the system comprising:
a plurality of beams, with each beam comprising:
an elongate web; and,
a first pair of elongate ribs integrally formed with and extending away from said elongate web in generally opposite directions;
a plurality of blocks arranged in columns, each of said blocks comprising:
a front face;
a rear face spaced from said front face by a distance defining the depth of said block;
a top surface;
a bottom surface spaced from said top surface by a distance defining the height of said block;
side surfaces spaced from each other by a distance defining the width of said block, with each side surface having a recess configured to receive a portion of an elongate rib of a support beam;
wherein said beams are arranged in a substantially parallel relation and operatively connected to the retaining wall at predetermined locations; and,
wherein the plurality of blocks are positioned between adjacent parallel beams such that the recesses of each block slidingly engage portions of said elongate ribs to form the retaining wall facia.

2. The system of claim 1, wherein each said support beam further comprises a second pair of elongate ribs extending away from said elongate web in generally opposite directions, with said first pair of elongate ribs spaced from said second pair of elongate ribs by a distance defining the span of said elongate ribs.

3. The system of claim 2 wherein said span of said elongate ribs is at least as great as a distance measured between said recesses of said side surfaces, and said rear face of each of said plurality of blocks.

4. The system of claim 2 wherein said span of said elongate ribs is less than a distance measured between said recesses of said side surfaces, and said rear face of each of said plurality of blocks, and wherein at least one of said pairs of elongate ribs is resiliently deformable such that when support beams are positioned between said vertically adjacent columns, at least one elongate rib of said pair of resiliently deformable elongate ribs deforms, thereby increasing said span to at least as great as said distance between said recesses and said rear face of each of said plurality of blocks.

5. The system of claim 1, wherein each elongate rib of said first pair of elongate ribs further comprises an angled flange for guiding said elongate ribs into said recesses.

6. The system of claim 1, further comprising a footing, with the footing providing support for said plurality of blocks.

7. The system of claim 1, further comprising at least one cap stone.

8. The system of claim 1, wherein each said block front face further comprises a split face.

9. The system of claim 8, wherein each said block front face further comprises at least one splitting recess.

10. The system of claim 1, wherein said blocks comprise composite masonry material.

11. The system of claim 1, further comprising adhesive material positioned between two adjacent blocks.

12. A retaining wall facia system, the system comprising:
a plurality of beams, with each beam comprising:
an elongate web; and,
a first pair of elongate ribs integrally formed with and extending away from said elongate web in generally opposite directions;
a plurality of brackets, with each bracket comprising a beam connecting portion and a retaining wall attaching portion;
a plurality of blocks arranged in columns, each of said blocks comprising:
a front face;
a rear face spaced from said front face by a distance defining the depth of said block;
a top surface;
a bottom surface spaced from said top surface by a distance defining the height of said block;
side surfaces spaced from each other by a distance defining the width of said block, with each side surface having a recess configured to receive a portion of an elongate rib of a support beam;
wherein the retaining wall portions of the brackets are connected to the retaining wall in a predetermined relation;
wherein at least two of the beams are slidingly connected to at least two of said beam connecting portions of said brackets, with the two beams being substantially parallel with respect to each other; and,
wherein the plurality of blocks are positioned between adjacent parallel beams such that the recesses of each block slidingly engage portions of said elongate ribs to form the retaining wall facia.

13. The system of claim 12 wherein each said support beam further comprises a second pair of elongate ribs extending away from said elongate web in generally opposite directions, with said first pair of elongate ribs spaced from said second pair of elongate ribs by a distance defining the span of said elongate ribs.

14. The system of claim 12 wherein each elongate rib of said first pair of elongate ribs further comprises an angled flange for guiding said elongate ribs into said recesses.

15. The system of claim 12, further comprising a footing, with the footing providing support for said plurality of blocks.

16. The system of claim 12, further comprising at least one cap stone.

17. The system of claim 12, wherein said brackets are attached to the retaining wall by a plurality of fastening elements.

18. A method of cladding a front surface of a retaining wall, the method comprising:
a. providing a plurality of blocks, with each block comprising: a front face; a rear face spaced from said front face by a distance defining the depth of said block; a top surface; a bottom surface spaced from said top surface by a distance defining the height of said block; side surfaces spaced from each other by a distance defining the width of said block, with each side surface having a recess configured to receive a portion of an elongate rib of a support beam;
b. providing at least two beams, with the beam comprising an elongate web and a first pair of elongate ribs integrally formed with and extending away from said elongate web in generally opposite directions;
c. connecting the beams to the front face of the retaining wall in a substantially parallel relation and at predetermined locations;
d. positioning the blocks between adjacent parallel beams such that the recesses of each block slidingly engage portions of said elongate ribs to form the retaining wall facia.

19. The method of claim 18, further comprising the step of providing a cap stone for the top surface of the uppermost block in a column of blocks.

20. A method of cladding a front surface of a retaining wall, the method comprising:
a. providing a plurality of blocks, with each block comprising: a front face; a rear face spaced from said front face by a distance defining the depth of said block; a top surface; a bottom surface spaced from said top surface by a distance defining the height of said block; side surfaces spaced from each other by a distance defining the width of said block, with each side surface having a recess configured to receive a portion of an elongate rib of a support beam;
b. providing at least two beams, with the beam comprising an elongate web and a first pair of elongate ribs integrally formed with and extending away from said elongate web in generally opposite directions;
c. a plurality of brackets, with each bracket comprising a beam connecting portion and a retaining wall attaching portion;
d. attaching the brackets to the front face of the retaining wall at predetermined locations;
e. connecting the beams to the brackets in a substantially parallel relation; and,
f. positioning the blocks between adjacent parallel beams such that the recesses of each block slidingly engage portions of said elongate ribs to form the retaining wall facia.
